(19) United States
(12) Patent Application Publication
(10) Pub. No.: US 2023/0295026 A1
(43) Pub. Date: Sep. 21, 2023

(54) METHODS AND COMPOSITIONS COMPRISING ANTI-SCALANTS

(71) Applicant: KEMIRA OYJ, HELSINKI (FI)

(72) Inventor: Rick GRIFFIN, Atlanta, GA (US)

(21) Appl. No.: 18/020,961

(22) PCT Filed: Aug. 13, 2021
(86) PCT No.: PCT/US2021/045895

§ 371 Date: Feb. 13, 2023

Related U.S. Application Data
(60) Provisional application No. 63/065,685, filed on Aug. 14, 2020.

(51) Int. Cl. C02F 5/10

(52) U.S. Cl. CPC C02F 5/10; C02F 2209/06; C02F 2209/02

(57) ABSTRACT

The present disclosure generally relates to methods and compositions for the treatment of scale, such as controlling, preventing, and/or inhibiting scale formation and/or the rate of scale formation, in a fluid in need of treatment, such as fluids used in and/or resulting from oil and gas operations, wherein said treatment comprises the use of one or more anti-scalants. The one or more anti-scalants may comprise desirable biodegradation characteristics as well as enhanced divalent ion tolerance, such as calcium ion tolerance.

### CROSS-REFERENCE TO RELATED APPLICATIONS

This application claims the priority benefit of U.S. Provisional Application Ser. No. 63/065,685 filed Aug. 14, 2020 entitled “METHODS AND COMPOSITIONS COMPRISING ANTI-SCALANTS” which is incorporated by reference herein in its entirety.

### FIELD OF THE ART

The present disclosure generally relates to methods and compositions comprising anti-scalants. Such anti-scalants are useful in a variety of applications, in particular those comprising one or more fluids in need of treatment, such as, for example, boiling and cooling water scale prevention, desalination, struvite control, and oilfield and gasfield applications, and in particular those comprising divalent ions, such as calcium.

### BACKGROUND

Scale deposits are typically formed by the precipitation and crystal growth of, for example, solid salts, oxides, and hydroxides, at a surface in contact with a fluid, such as water or water vapor. In industrial fluids, such as produced waters in oil and gas extraction, and in process waters used or generated in mineral processing, alkaline earth metal or transition metals (cations) are generally present, including calcium, barium, strontium, iron, and magnesium. In addition to cationic species, several anions are present as well, namely bicarbonate, carbonate, sulfate, phosphate, sulfide, and silicate. Precipitation of these ions occurs when solubility is exceeded either in the bulk fluid or at the surfaces on which the scale forms, including pipes and autoclaves. Thermodynamically, crystallization or precipitation becomes feasible when the activity of ions in solution is above their saturation limit. The kinetics of precipitation can also be a key determinant of the severity of scaling, where nucleation of scale formation on surfaces induces the growth of crystals and low concentration of nucleation sites can slow the crystallization kinetics.

In industrial processing systems and circuits, scale formation can cause various problems. For example, in mineral processing systems, scale formation can cause reduced heat transfer efficiency, flow restrictions such as plugging of pipelines, under-deposit corrosion and microbiological growth resulting in reduced metal recovery, and increased cleaning costs and equipment damage and/or failure. These problems ultimately cause losses in production, increased operating costs and increased capital equipment expenditures. Scale formation can result in adverse effects, such as, for example, reduced production rates; flow restrictions which may include blockages and/or full plugging of pipelines, wellbores, and/or formations; under-deposit corrosion; increased water usage, and increased cleaning costs and equipment damage and/or failure in a number of industrial systems and circuits. These challenges ultimately cause losses in production, increased operating costs, and increased capital equipment expenditures.

In addition to scaling in aqueous solutions, scale formation can form in many processing fluids where high levels of dissolved solids are present, such as processes that include heat transfer apparatus(es). These processes include, but are not limited to, processes that rely on autoclaves and heat exchangers, such as carbon in leach circuits, carbon in pulp circuits, pressure oxidation equipment, flotation processes and thickener overflows. In cases where a heat transfer apparatus is used, such as heat exchangers or autoclaves, scale of a sufficient thickness reduces heat transfer efficiency. Such processes include, but are not limited to mining, mineral processing, oil and gas exploration and production, pulp, cardboard, and/or paper processing, and coal slurry transport.

Moreover, biodegradability of anti-scalants is highly desirable as, for example, anti-scalants used in the oil and gas industry must meet various environmental regulations, such as regulations regarding biodegradation levels of the anti-scalant.

As such, the development of anti-scalants that demonstrate improved biodegradability is of great interest and great need to a number of industries.

### BRIEF SUMMARY

The present disclosure generally relates to an anti-scalant composition comprising a copolymer of sodium allyl sulfonate and maleic anhydride or its neutralized salt, wherein the maleic anhydride is derivatized or reacted with one or more glycol ethers, optionally diethylene glycol methyl ether. In some embodiments, said anti-scalant composition may comprise a fluid in need of treatment. In some embodiments, the anti-scalant composition may exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, the anti-scalant composition may exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, the anti-scalant composition may exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, the anti-scalant composition may be capable of reaching a level of at least 20% biodegradation 28 days after introduction into said fluid in need of treatment. In some embodiments, said maleic anhydride may be derivatized with one or more glycol ethers selected from the group consisting of ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether. In some embodiments, said maleic anhydride may be derivatized with diethylene glycol methyl ether (DEGME).

In some embodiments, the level of incorporation of the glycol ether in said anti-scalant may be about 10% or less, 10% or more, 20% or more, 30% or more, 40% or more, 50% or more, 60% or more, 70% or more, 80% or more, or 90% or more. In some embodiments, the level of incorporation of the glycol ether in said anti-scalant may be from about 10% to about 60%, from about 20% to about 60%, from about 30% to about 60%, from about 40% to about 60%, from about 50% to about 60%, from about 30% to about 50%, or from about 40% to about 50%. In some embodiments, the molecular weight of said anti-scalant may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some embodiments, the molecular weight of the anti-scalant may be from about 1500 Da to about 5000 Da. In some embodiments, the maleic anhydride may be derivatized with a glycol ether, optionally DEGME; the level of incorporation of the glycol ether is from about 30% to about 60%; and the molecular weight of the anti-scalant is from about 1500 Da to about 5000 Da. In some embodiments, the anti-scalant may exhibit enhanced divalent ion tolerance, optionally wherein said divalent ions comprise calcium and/or magnesium. In some embodiments, the anti-scalant may comprise enhanced divalent ion tolerance, wherein said divalent ions comprise calcium and/or magnesium. In some embodiments, the ratio of sodium allyl sulfonate:maleic anhydride may be from about 0.1:99.9 to 99.9:0.1. In some embodiments, the amount of said anti-scalant may be 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, the fluid in need of treatment may comprise a circulating fluid, optionally wherein said circulating fluid comprises any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or in a system that is utilized in coal processing (e.g., coal slurry transport). In some embodiments, the fluid in need of treatment may comprise fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport). In some embodiments, the fluid in need of treatment may comprise one or more types of scale, optionally wherein said scale comprises insoluble substances such as insoluble salts, including without limitation sulfate, carbonate and phosphate salts such as calcium carbonate, calcium sulfate, calcium phosphate, barium sulfate, strontium sulfate, vivianite, iron sulfide, zinc sulfide, lead sulfide, and struvite. In some embodiments, the fluid in need of treatment may comprise boiler water, cooling water, seawater (e.g., in oil platform applications), brackish water, oilfield water (e.g., topside and/or downhole), coal processing water, or industrial treatment plant water. In some embodiments, the fluid in need of treatment may comprise oilfield water in need of treatment. In some embodiments, the fluid in need of treatment may comprise downhole water that is pumped underground (e.g., for enhanced oil recovery). In some embodiments, the fluid in need of treatment may comprise topside oilfield water. In some embodiments, the fluid in need of treatment may comprise any fluid resulting from any part of a process associated with enhanced oil recovery. In some embodiments, the fluid in need of treatment may comprise produced water. In some embodiments, the fluid in need of treatment may comprise water that is used in and/or results from any part of a gas recovery process. In some embodiments, the fluid in need of treatment may comprise water that is used in and/or results from any part of the processing of pulp, paper, and/or cardboard. In some embodiments, the fluid in need of treatment may comprise water that is used in and/or results from any part of reverse osmosis. In some embodiments, the fluid in need of treatment may comprise water that is used in and/or results from any part of a geothermal process or application.

Moreover, the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with one or more glycol ethers, optionally diethylene glycol methyl ether.

In some embodiments, the one or more anti-scalants may exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more. In some embodiments, the one or more anti-scalants may exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, the one or more anti-scalants may exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%, wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, 28 days after addition or introduction, said one or more anti-scalants may reach a level of at least 20% biodegradation. In some embodiments, said maleic anhydride may be derivatized with one or more glycol ethers selected from the group consisting of ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether. In some embodiments, said maleic anhydride may be derivatized with diethylene glycol methyl ether (DEGME).

In some embodiments, the level of incorporation of the glycol ether in said one or more anti-scalants may be about 10% or less, 10% or more, 20% or more, 30% or more, 40% or more, 50% or more, 60% or more, 70% or more, 80% or more, or 90% or more. In some embodiments, the level of incorporation of the glycol ether in said one or more anti-scalants may be from about 10% to about 60%, from about 20% to about 60%, from about 30% to about 60%, from about 40% to about 60%, from about 50% to about 60%, from about 30% to about 50%, or from about 40% to about 50%. In some embodiments, the molecular weight of said one or more anti-scalants may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some embodiments, the molecular weight of the one or more anti-scalants may be from about 1500 Da to about 5000 Da.

In some embodiments, the maleic anhydride may be derivatized with a glycol ether, optionally DEGME; the level of incorporation of the glycol ether is from about 30% to about 60%; and the molecular weight of the biodegradable anti-scalant is from about 1500 Da to about 5000 Da. In some embodiments, the one or more anti-scalants may comprise enhanced divalent ion tolerance, optionally wherein said divalent ions comprise calcium and/or magnesium. In some embodiments, the one or more anti-scalants may comprise enhanced divalent ion tolerance, wherein said divalent ions comprise calcium and/or magnesium. In some embodiments, the ratio of sodium allyl sulfonate:maleic anhydride may be from about 0.1:99.9 to 99.9:0.1. In some embodiments, the amount of said one or more anti-scalants added or introduced may be 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more. In some embodiments, said scale may comprise one or more insoluble salts. In some embodiments, said scale may comprise insoluble salts, including sulfate, carbonate and phosphate salts such as calcium carbonate, calcium sulfate, calcium phosphate, barium sulfate, strontium sulfate, vivianite, iron sulfide, zinc sulfide, lead sulfide, and struvite.

In some embodiments, treatment of said fluid with said one or more anti-scalants may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation as compared to a method which did not comprise the use of said one or more biodegradable anti-scalants. In some embodiments, said method may comprise adding or introducing an amount of said one or more anti-scalants which is an amount necessary to achieve a desired effect. In some embodiments, said one or more anti-scalants may be provided in liquid form, such as an aqueous solution. In some embodiments, said one or more anti-scalants may be provided in dry form and/or as a powder. In some embodiments, said one or more anti-scalants may be water-soluble. In some embodiments, said addition or introduction of one or more anti-scalants may be a continuous application. In some embodiments, said addition or introduction of one or more anti-scalants may be a direct injection. In some embodiments, said addition or introduction of one or more anti-scalants may be effected intermittently. In some embodiments, treatment may occur at atmospheric temperature. In some embodiments, treatment may occur at 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, or 100° C. or more, 125° C. or more, or 150° C. or more. In some embodiments, the pH at which treatment may occur is the pH of a fluid in need of treatment.

In some embodiments, treatment may prevent and/or may reduce the plugging of production lines, filters, pumps, and/or screens that are used in conjunction with said fluid in need of treatment. In some embodiments, treatment may prevent and/or may reduce plugging of a fluid conduit disposed in an injection wellbore. In some embodiments, treatment may prevent and/or may reduce plugging of a subterranean formation. In some embodiments, treatment may prevent and/or may reduce plugging of a production well and/or components associated with a production well.

In some embodiments, the fluid in need of treatment may comprise a circulating fluid, optionally wherein said circulating fluid comprises any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or in a system that is utilized in coal processing (e.g., coal slurry transport). In some embodiments, the fluid in need of treatment may comprise fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport). In some embodiments, the fluid in need of treatment may comprise one or more types of scale, optionally wherein said scale comprises insoluble substances such as insoluble salts, including without limitation sulfate, carbonate and phosphate salts such as calcium carbonate, calcium sulfate, calcium phosphate, barium sulfate, strontium sulfate, vivianite, iron sulfide, zinc sulfide, lead sulfide, and struvite. In some embodiments, the fluid in need of treatment may comprise boiler water, cooling water, seawater (e.g., in oil platform applications), brackish water, oilfield water (e.g., topside and/or downhole), coal processing water, or industrial treatment plant water. In some embodiments, the fluid in need of treatment may comprise oilfield water in need of treatment. In some embodiments, the fluid in need of treatment may comprise downhole water that is pumped underground (e.g., for enhanced oil recovery). In some embodiments, the fluid in need of treatment may comprise topside oilfield water. In some embodiments, the fluid in need of treatment may comprise any fluid resulting from any part of a process associated with enhanced oil recovery. In some embodiments, the fluid in need of treatment may comprise produced water. In some embodiments, the fluid in need of treatment may comprise water that is used in and/or results from any part of a gas recovery process. In some embodiments, the fluid in need of treatment may comprise water that is used in and/or results from any part of the processing of pulp, paper, and/or cardboard. In some embodiments, the fluid in need of treatment may comprise water that is used in and/or results from any part of reverse osmosis. In some embodiments, the fluid in need of treatment may comprise water that is used in and/or results from any part of a geothermal process or application.

Furthermore, the present disclosure generally relates to a composition suitable for use in the treatment of scale, wherein said composition comprises i. an effective amount of one or more anti-scalants, wherein said one or more anti-scalants comprise a copolymer of sodium allyl sulfonate and maleic anhydride or its neutralized salt, wherein the maleic anhydride is derivatized with one or more glycol ethers, and further wherein the molecular weight of the one or more biodegradable anti-scalants is from about 1500 Da to about 5000 Da; and optionally ii. a fluid in need of treatment.

Moreover, the present disclosure generally relates to a composition suitable for use in the treatment of scale, wherein said composition comprises i. an effective amount of one or more anti-scalants, wherein said one or more anti-scalants comprise a copolymer of sodium allyl sulfonate and maleic anhydride or its neutralized salt, wherein the maleic anhydride is derivatized with diethylene glycol methyl ether (DEGME); and optionally ii. a fluid in need of treatment.

Furthermore, the present disclosure generally relates to a composition suitable for use in the treatment of scale, wherein said composition comprises i. an effective amount of one or more anti-scalants, wherein said one or more anti-scalants comprise a copolymer of sodium allyl sulfonate and maleic anhydride or its neutralized salt, wherein the maleic anhydride is derivatized with diethylene glycol methyl ether (DEGME), and further wherein the molecular weight of the one or more anti-scalants is from about 1500 Da to about 5000 Da; and optionally ii. a fluid in need of treatment.

Moreover, the present disclosure generally relates to a composition suitable for use in the treatment of scale, wherein said composition comprises i. an effective amount of one or more anti-scalants, wherein said one or more anti-scalants comprise a copolymer of sodium allyl sulfonate and maleic anhydride or its neutralized salt, wherein the maleic anhydride is derivatized with diethylene glycol methyl ether (DEGME), and further wherein the molecular weight of the one or more anti-scalants is from about 1500 Da to about 5000 Da; and optionally ii. a fluid in need of treatment; further optionally wherein said one or more anti-scalants are capable of reaching a level of at least 20% biodegradation 28 days after introduction into said fluid in need of treatment, and further optionally wherein said one or more anti-scalants: a. exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%; b. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or c. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%; wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

Furthermore, the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with one or more glycol ethers and further wherein the molecular weight of the one or more biodegradable anti-scalants is from about 1500 Da to about 5000 Da.

Moreover, the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with diethylene glycol methyl ether (DEGME).

Furthermore, the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with diethylene glycol methyl ether (DEGME), and further wherein the molecular weight of the one or more anti-scalants is from about 1500 Da to about 5000 Da.

Moreover, the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with diethylene glycol methyl ether (DEGME), and further wherein the molecular weight of the one or more anti-scalants is from about 1500 Da to about 5000 Da, optionally wherein said one or more anti-scalants are capable of reaching a level of at least 20% biodegradation 28 days after introduction into said fluid in need of treatment, and further optionally wherein said one or more anti-scalants: i. exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%; ii. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or iii. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%; wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

Furthermore, the present disclosure generally relates to an anti-scalant composition comprising a copolymer of sodium allyl sulfonate and maleic anhydride or its neutralized salt, wherein the maleic anhydride is derivatized with diethylene glycol methyl ether (DEGME), and further wherein the molecular weight of the one or more anti-scalants is from about 1500 Da to about 5000 Da; further optionally wherein said anti-scalant composition: i. exhibits enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%; ii. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or iii. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%; wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

### BRIEF DESCRIPTION OF THE SEVERAL VIEWS OF THE DRAWING

FIG. 1 shows the biodegradation of various different compositions over a 28-day time period in accordance with Example 2.

FIG. 2 shows the results of anti-scalant tests performed in accordance with Example 3.

FIG. 3 shows the calcium tolerance of various different compositions in accordance with Example 4.

FIG. 4 shows the magnesium tolerance of various different compositions in accordance with Example 4.

FIG. 5 shows the biodegradation of two different compositions over a 28-day time period in accordance with Example 5.

### DETAILED DESCRIPTION

### Definitions

As used herein the singular forms “a”, “an”, and “the” include plural referents unless the context clearly dictates otherwise. All technical and scientific terms used herein have the same meaning as commonly understood to one of ordinary skill in the art to which this invention belongs unless clearly indicated otherwise.

As used herein, the term “enhanced oil recovery” or “EOR” (sometimes also known as improved oil recovery (“IOR”) or tertiary mineral oil production) generally refers to techniques for increasing the amount of unrefined petroleum (for example, crude oil) that may be extracted from an oil reservoir, such as an oil field. Examples of EOR techniques include, for example, miscible gas injection (e.g., carbon dioxide flooding), chemical injection, which is sometimes referred to as chemical enhanced oil recovery (“CEOR”), and which includes, for example, polymer flooding, alkaline flooding, surfactant flooding, micellar polymer flooding, conformance control operations, as well as combinations thereof such as alkaline-polymer flooding or alkaline-surfactant-polymer flooding, microbial injection, and thermal recovery (e.g., cyclic steam, steam flooding, or fire flooding). In some embodiments, the EOR operation may include a polymer (“P”) flooding operation, an alkaline-polymer (“AP”) flooding operation, a surfactant-polymer (“SP”) flooding operation, an alkaline-surfactant-polymer (“ASP”) flooding operation, a conformance control operation, or any combination thereof.

As used herein, the terms “polymer flood” or “polymer flooding” generally refer to a chemical enhanced EOR technique that typically involves injecting an aqueous fluid that is viscosified with one or more water-soluble polymers through injection boreholes into an oil reservoir to mobilize oil left behind after primary and/or secondary recovery. As a general result of the injection of one or more polymers, the oil may be forced in the direction of the production borehole, and the oil may be produced through the production borehole. Details of examples of polymer flooding and of polymers suitable for this purpose are disclosed, for example, in “Petroleum, Enhanced Oil Recovery, Kirk-Othmer, Encyclopedia of Chemical Technology, online edition, John Wiley & Sons, 2010”, which is herein incorporated by reference in its entirety. One or more surfactants may be injected (or formed in situ) as part of the EOR technique. Surfactants may function to reduce the interfacial tension between the oil and water, which may reduce capillary pressure and improve mobilization of oil. Surfactants may be injected with polymers (e.g., a surfactant-polymer (SP) flood), or formed in-situ (e.g., an alkaline-polymer (AP) flood), or a combination thereof (e.g., an alkaline-surfactant-polymer (ASP) flood). As used herein, the terms “polymer flood” and “polymer flooding” encompass all of these EOR techniques.

As used herein, the term “monomer” generally refers to nonionic monomers, anionic monomers, cationic monomers, zwitterionic monomers, betaine monomers, and amphoteric ion pair monomers.

As used herein, the terms “polymer,” “polymers,” “polymeric,” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, e.g., polymerizing, a particular monomer. Unless otherwise specified, a polymer may also comprise a “copolymer” that may comprise two or more different recurring units that may be formed by, e.g., copolymerizing, two or more different monomers, and/or by chemically modifying one or more recurring units of a precursor polymer. Unless otherwise specified, a polymer or copolymer may also comprise a “terpolymer” that may comprise polymers that may comprise three or more different recurring units. The term “polymer” as used herein is intended to include both the acid form of the polymer as well as its various salts. Polymers may be amphoteric in nature, i.e., containing both anionic and cationic substituents, although not necessarily in the same proportions.

As used herein the term “nonionic monomer” generally refers to a monomer that possesses a neutral charge. Nonionic monomers may comprise but are not limited to comprising monomers of acrylamide (“AMD”), acrylic, methacrylic, methacrylamido, vinyl, allyl, ethyl, and the like, all of which may be substituted with a side chain selected from, for example, an alkyl, arylalkyl, dialkyl, ethoxyl, and/or hydrophobic group. In some embodiments, a nonionic monomer may comprise AMD. In some embodiments, nonionic monomers may comprise but are not limited to comprising vinyl amide (e.g., acrylamide, methacrylamide, N-methylacrylamide, N,N-dimethylacrylamide), acryloylmorpholine, acrylate, maleic anhydride, N-vinylpyrrolidone, vinyl acetate, N-vinyl formamide and their derivatives, such as hydroxyethyl (methyl)acrylate CH2=CR—COO—CH2CH2OH (I) and CH2=CR—CO—N(Z1)(Z2) (2)N-substituted (methyl)acrylamide (II). R═H or Me; Z1=5-15C alkyl; 1-3C alkyl substituted by 1-3 phenyl, phenyl or 6-12C cycloalkyl (both optionally substituted) and Z2=H; or Z1 and Z2 are each 3-10C alkyl; (II) is N-tert. hexyl, tert. octyl, methylundecyl, cyclohexyl, benzyl, diphenylmethyl or triphenyl acrylamide. Nonionic monomers further may include dimethylaminoethylacrylate (“DMAEMA”), dimethylaminoethyl methacrylate (“DMAEM”), N-isopropylacrylamide and N-vinyl formamide.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

Examples of anionic monomers which may be used herein which further may be substituted with other groups include but are not limited to those comprising acrylamide (“AMD”), acrylic, methacrylic, methacrylamido, vinyl, allyl, ethyl, and the like; maleic monomers and the like; calcium diacrylate; and/or any monomer substituted with a carboxylic acid group or salt thereof. In some embodiments, these anionic monomers may be substituted with a carboxylic acid group, and include, for example, acrylic acid, and methacrylic acid. In some embodiments, an anionic monomer which may be used herein may be a (meth)acrylamide monomer wherein the amide group has been hydrolyzed to a carboxyl group. Said monomer may be a derivative or salt of a monomer according to the embodiments. Additional examples of anionic monomers comprise but are not limited to those comprising sulfonic acids or a sulfonic acid group, or both. In some embodiments, the anionic monomers which may be used herein may comprise a sulfonic function that may comprise, for example, acrylamide tertiary butyl sulfonic acid (also known as 2-acrylamido-2-methylpropane sulfonic acid or N-t-butyl acrylamide sulfonic acid) (“ATBS”); vinylsulfonic acid; 4-styrenesulfonic acid; and/or any salts of any of these moieties/monomers. In some embodiments, anionic monomers may comprise organic acids. In some embodiments, anionic monomers may comprise acrylic acid, methacrylic acid, maleic acid, itaconic acid, acrylamido methylpropane sulfonic acid, vinylphosphonic acid, styrene sulfonic acid and their salts such as sodium, ammonium and potassium.

As used herein, the term “cationic monomer” generally refers to a monomer that possesses a positive charge. Examples of cationic monomers may comprise but are not limited to those comprising acryloyloxy ethyl trimethyl ammonium chloride (“AETAC”), methacryloyloxyethyltrimethylammonium chloride, methacrylamidopropyltrimethylammonium chloride (“MAPTAC”), acrylamidopropyltrimethylammonium chloride, methacryloyloxyethyldimethylammonium sulfate, dimethylaminoethyl acrylate, dimethylaminopropylmethacrylamide, Q6, Q6o4, and/or diallyldimethylammonium chloride (“DADMAC”).

Said cationic monomers may also comprise but are not limited to comprising dialkylaminoalkyl acrylates and methacrylates and their quaternary or acid salts, including, but not limited to, dimethylaminoethyl acrylate methyl chloride quaternary salt (“DMAEA.MCQ”), dimethylaminoethyl acrylate methyl sulfate quaternary salt (“DMAEM.MCQ”), dimethyaminoethyl acrylate benzyl chloride quaternary salt (“DMAEA.BCQ”), dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate and diallyldialkylammonium halides such as diallyldiethylammonium chloride and diallyldimethyl ammonium chloride. Alkyl groups may generally but are not limited to those comprising C₁₋₈ alkyl groups. In some embodiments, cationic monomers may comprise quaternary ammonium or acid salts of vinyl amide, vinyl carboxylic acid, methacrylate and their derivatives.

As used herein, the term “produced water” generally refers to any aqueous fluids produced during any type of industrial process, e.g., an oil or gas extraction or recovery process, e.g., a mining process, e.g., a pulp, paper, or cardboard process, e.g., a coal transport process, or any portion thereof, such as but not limited to any enhanced oil recovery process or any portion thereof. Typically the produced water may be obtained during an industrial process involving the use of water, and, in some instances, the use of one or more water soluble polymers.

According to some embodiments, the produced water may be formed during any part of a process related to polymer flooding and may comprise any components and/or chemicals related to any part of said polymer flooding. This may be referred to as “polymer flooded produced water” or “polymer flooding produced water”, and the term produced water is to be understood to encompass any type of polymer flooded produced water or polymer flooding produced water.

As used herein, the terms “scale” and “mineral scale” generally refer to the accumulation of unwanted material on solid surfaces, and particularly includes environments wherein such deposition is to the detriment of the functioning, stability and/or physical integrity of the solid surface comprising such deposition such as an apparatus on which scale forms. In some instances, such unwanted material may include insoluble substances such as insoluble salts, that have a tendency to form in aqueous systems, such as boiler water, e.g., calcium phosphate scale, cooling water, e.g., calcium carbonate scale, seawater (e.g., in oil platform applications), brackish water, oilfield water, municipal treatment plant water, paper mill water (such as water used to process pulp, paper, and/or cardboard), mining water, water resulting from any part of a method associated with enhanced oil recovery, water resulting from gas recovery, water resulting from oil recovery, and industrial treatment plant water. In some embodiments, scale may include but is not limited to including insoluble substances such as insoluble salts, including without limitation sulfate, sulfide, carbonate and phosphate salts such as calcium carbonate, calcium sulfate, calcium phosphate, barium sulfate, strontium sulfate, vivianite, iron sulfide, zinc sulfide, lead sulfide, and struvite, which substances have a tendency to form in a fluid in need of treatment.

As used herein, the terms “anti-sealant”, “scale modifier”, “anti-scale agent”, “scale modifier”, and the like, generally refer to chemical compounds, e.g., polymers, or compositions containing such compounds, that may be added to a fluid, to interfere with nucleation, growth, and/or agglomeration of particles that may form scale, and thereby control, reduce, inhibit, or prevent the formation, deposition, and/or adherence of scale deposits on substrate surfaces in contact with scale-forming fluids. The anti-scalants may control, reduce, inhibit, or prevent the formation of scale (for example, the total amount and/or rate of formation of scale such as sulfur-based scales) in a particular system as compared to an equivalent system that does not contain the added anti-scalant. In some embodiments, an anti-scalant is added to a fluid in which scale may form, which may be referred to as a fluid in need of treatment.

In some embodiments, an anti-scalant may comprise a copolymer of sodium allyl sulfonate and maleic anhydride or its neutralized salt, further wherein the maleic anhydride is derivatized or reacted with one or more glycol ethers. Such glycol ethers include, but are not limited to, ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether. In some instances, the derivatization reaction, such as one comprising one or more glycol ethers, may comprise use of a co-solvent, such as alcohols, e.g., methanol, ethanol, and/or isopropanol. In some instances, the maleic anhydride is derivatized with diethylene glycol methyl ether (DEGME).

In some embodiments, the level of incorporation of a glycol ether in an anti-scalant, e.g., a copolymer of sodium allyl sulfonate and maleic anhydride or its neutralized salt, wherein the maleic anhydride is derivatized with a glycol ether, may be about 10 mol % or less, 10 mol % or more, 20 mol % or more, 30 mol % or more, 40 mol % or more, 50 mol % or more, 60 mol % or more, 70 mol % or more, 80 mol % or more, or 90 mol % or more. In some instances, the level of incorporation of a glycol ether in an anti-scalant, e.g., a copolymer of sodium allyl sulfonate and maleic anhydride or its neutralized salt, wherein the maleic anhydride is derivatized or reacted with a glycol ether, may be from about 10 mol % to about 60 mol %, from about 20 mol % to about 60 mol %, from about 30 mol % to about 60 mol %, from about 40 mol % to about 60 mol %, from about 50 mol % to about 60 mol %, from about 30 mol % to about 50 mol %, or from about 40 mol % to about 50 mol %. In some embodiments, the molecular weight of the anti-scalant, e.g., a copolymer of sodium allyl sulfonate and maleic anhydride or its neutralized salt, wherein the maleic anhydride is derivatized with a glycol ether, may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some instances, the molecular weight of the anti-scalant, e.g., a copolymer of sodium allyl sulfonate and maleic anhydride or its neutralized salt, wherein the maleic anhydride is derivatized with a glycol ether, may be from about 1500 Da to about 5000 Da. In some embodiments, an anti-scalant may comprise a copolymer of sodium allyl sulfonate and maleic anhydride or its neutralized salt, wherein the maleic anhydride is derivatized with a glycol ether, e.g., DEGME, wherein the level of incorporation of the glycol ether is from about 30 mol % to about 60 mol %, further wherein the molecular weight of the anti-scalant is from about 1500 Da to about 5000 Da. In some embodiments, an anti-scalant may reach a desired level of biodegradation after a desired time period, such as, for instance, at least 20% biodegradation after 28 days. In some instances, the degree of biodegradation may be calculated by dividing the observed biochemical oxygen demand (“BOD”) with the theoretical BOD for full degradation of the molecule, which value can either be calculated or measured. In some instances, a sample, e.g., a polymer, is determined to be fully biodegraded when the BOD ceases to change during a biodegradation test, such as those presented in Example 2.

As discussed further infra, it was surprisingly discovered that anti-scalants according to the invention, optionally biodegradable anti-scalants comprising one or more of the anti-scalants discussed herein, may comprise an “enhanced ion tolerance”, i.e., the ability of such anti-scalant to prevent or slow scaling in a fluid and/or of a surface, in relation to conventional anti-scalants, is not precluded or reduced in the presence of one or more divalent ions, e.g., calcium, e.g., magnesium, e.g., wherein such ions are present at high concentrations. For example, the tolerance of anti-scalants according to the invention may in some instances be totally or substantially retained in the presence of fluids, e.g., aqueous fluids, comprising up to the solubility limit of a divalent cation and/or salt comprising a divalent cation, e.g., calcium chloride.

The enhanced tolerance of the subject anti-scalants to divalent ions, e.g., calcium and/or magnesium, may be measured by different means. An exemplary method comprises comparing the 80% transmission value of test solutions comprising the anti-scalant composition and varying concentrations of one or more divalent ions to the 80% transmission value of test solutions which either have no anti-scalant added or other anti-scalants or biodegradable anti-scalants added, wherein the 80% transmission value is measured at 420 nm wavelength by a spectrophotometer and wherein the value represents the concentration of divalent ions at which the transmission value of the test sample is 80%, such as, for example, the tests performed in Example 4 infra.

As used herein, the term “biodegradation” generally refers to the breakdown, for example the chemical breakdown, of materials (e.g. (co)polymers) by microorganisms such as bacteria and fungi or other biological activity. Such breakdown may be naturally-occurring or induced by human action.

As used herein, the terms “biodegradable anti-scalant”, “biodegradable scale modifier”, “biodegradable anti-scale agent”, “biodegradable scale modifier”, and the like, generally refer to an anti-scalant that is capable of undergoing biodegradation. In some instances, the amount of biodegradation may be an amount necessary to meet environmental regulations or requirements for discharge and/or reuse of a composition comprising the biodegradable anti-scalant. In some embodiments, the biodegradable anti-scalant is degraded, such as biodegraded by naturally-occurring processes and/or human action.

As used herein, the terms “treatment of scale”, “treating scale”, “preventing scale”, “controlling scale”, and “inhibiting scale”, the like, generally refer to using anti-scalants and/or compositions comprising anti-scalants, such as those described herein, to treat, reduce, control, prevent, and/or inhibit the amount of scale formed and/or treat, reduce, control, prevent, and/or inhibit the rate of formation of scale in various industrial processes and systems in which scale may form.

As used herein “anti-scalant tolerance” refers to the relative retention of an anti-scalant's ability to treat, reduce, control, prevent, and/or inhibit the amount of scale formed and/or treat, reduce, control, prevent, and/or inhibit the rate of formation of scale in a fluid and/or on a surface under specific conditions, e.g., such as when the anti-scalant is in the presence of divalent cations, such as calcium and magnesium and salts thereof, optionally high concentrations up to the solubility limit.

As used herein, the term “fluid in need of treatment” generally refers to any fluid, typically an aqueous fluid, which may comprise scale and/or in which scale may form. In some embodiments, a fluid in need of treatment may comprise produced water. In some embodiments, a fluid in need of treatment may comprise water related to gas production and/or gas exploration processes. In some embodiments, a fluid in need of treatment may comprise sea water or other brackish water. In some instances, a fluid in need of treatment may comprise boiler water, cooling water, seawater (e.g., in oil platform applications), brackish water, oilfield water, municipal treatment plant water, paper mill water (such as water used to process pulp, paper, and/or cardboard), mining water, water resulting from any part of a method associated with enhanced oil recovery, reverse osmosis process water, water used in geothermal applications or methods, water resulting from gas recovery, water resulting from oil recovery, and/or industrial treatment plant water. In some instances, a fluid in need of treatment may comprise a circulating fluid. In some embodiments, the circulating fluid is utilized in, or is a component of, a mining process, or is in a system that is utilized in a mining process. In some embodiments, the circulating fluid is utilized in, or is a component of, a pulp, paper, and/or cardboard-related process, or is in a system that is utilized in the processing of pulp, paper, and/or cardboard. In some embodiments, the circulating fluid is utilized in, or is a component of, an oil and gas exploration or production process, or is in a system that is utilized in an oil and gas exploration and production process. In some embodiments, the circulating fluid is utilized in, or is a component of, coal processing, or is in a system that is utilized in coal processing (e.g., coal slurry transport). In some embodiments, the circulating fluid is utilized in, or is a component of a reverse osmosis process. In some embodiments, the circulating fluid is utilized in, or is a component of a geothermal application or method.

### Methods and Compositions

As discussed supra, anti-scalants which are biodegradable is highly desirable as, for example, anti-scalants used in the oil and gas industry as well as other industries must meet various environmental regulations, such as regulations regarding degradation of the anti-scalant in the environment. Moreover, anti-scalants which possess improved anti-scalant tolerance, i.e., which substantially or completely retain their ability to prevent or reduce scale formation under specific conditions is an additional consideration in developing improved anti-scalants. In particular anti-scalants which possess improved tolerance in the presence of ions, such as divalent ions, e.g., calcium and/or magnesium ions, e.g., wherein such divalent ions are present at high concentrations, e.g., up to the solubility limit thereof in the fluid, i.e., a fluid in need of treatment, is highly desirable. This is desirable as many fluids in need of treatment may comprise divalent ions such as calcium, sometimes in high amounts, and if the anti-scalant forms a complex with the calcium ions, precipitation of the anti-scalant may occur thereby lessening or abolishing the effectiveness of the anti-scalant. Unfortunately, conventional anti-scalants generally do not comprise desired biodegradation characteristics and/or desired tolerance characteristics in the presence of divalent ions, e.g., divalent cations such as calcium and magnesium, particularly when such divalent ions are present in high amounts. As such, there is a need for anti-scalants that comprise enhanced biodegradability and divalent ion tolerance.

Disclosed herein are methods and compositions for the treatment or prevention of scale, such as scale resulting from any process related to oil or gas production, extraction, and/or recovery; as well as any industrial process in which scale formation, is problematic to said process or to the functioning, stability, and/or physical integrity of materials such as apparatus used in such processes, wherein said methods and compositions comprise one or more anti-scalants according to the invention. Further disclosed herein are environments such as oil and gas wells and other environments wherein scale formation, is problematic which are treated with an amount of one or more anti-scalants effective to reduce scale formation or deposition. In some instances, such anti-scalants may reach a desired level of biodegradation after a desired time period, such as, for instance, at least 20% biodegradation after 28 days, which in some instances may allow for discharge of a treated fluid into the environment and/or reuse of the treated fluid in one or more additional desired processes.

As shown infra, it was surprisingly found that anti-scalants described herein may comprise “enhanced tolerance”, i.e., they better retain the ability to prevent or reduce scaling, in the presence of fluids comprising one or more divalent ions, e.g., calcium, e.g., magnesium, in some instances wherein the concentration of such divalent ions in the fluid may be relatively high. For example, in some instances the subject anti-scalants may be substantially or completely tolerant to divalent ions, i.e., the ability of the anti-scalant to prevent or reduce scaling, in the presence of fluids, e.g., aqueous fluids, comprising up to the solubility limit of a divalent ion and/or salt thereof, e.g., calcium chloride is substantially or totally retained.

In some instances, such enhanced divalent ion tolerance, e.g., calcium and/or magnesium tolerance, may be as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%, such as, for example, the tests performed in Example 4 infra. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%. In some instances, the anti-scalant composition comprising enhanced ion tolerance may be at a concentration of about 1000 ppm in the composition. In some instances, the anti-scalant composition comprising enhanced ion tolerance may be at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

In some embodiments, said anti-scalant may comprise a copolymer of sodium allyl sulfonate and maleic anhydride or its neutralized salt, further wherein the maleic anhydride is derivatized with one or more glycol ethers. Such glycol ethers include, but are not limited to, ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether. In some instances, the derivatization reaction, such as one comprising one or more glycol ethers, may comprise use of a co-solvent, such as alcohols, e.g., methanol, ethanol, and/or isopropanol. In some embodiments, said anti-scalant may comprise diethylene glycol methyl ether (“DEGME”). In some embodiments, the level of incorporation of a glycol ether in said anti-scalant, e.g., a copolymer of sodium allyl sulfonate and maleic anhydride or its neutralized salt, wherein the maleic anhydride is derivatized with a glycol ether, may be about 10 mol % or less, 10 mol % or more, 20 mol % or more, 30 mol % or more, 40 mol % or more, 50 mol % or more, 60 mol % or more, 70 mol % or more, 80 mol % or more, or 90 mol % or more. In some instances, the level of incorporation of a glycol ether in said anti-scalant, e.g., a copolymer of sodium allyl sulfonate and maleic anhydride or its neutralized salt, wherein the maleic anhydride is derivatized with a glycol ether, may be from about 10 mol % to about 60 mol %, from about 20 mol % to about 60 mol %, from about 30 mol % to about 60 mol %, from about 40 mol % to about 60 mol %, from about 50 mol % to about 60 mol %, from about 30 mol % to about 50 mol %, or from about 40 mol % to about 50 mol %. In some embodiments, the molecular weight of the anti-scalant, e.g., a copolymer of sodium allyl sulfonate and maleic anhydride or its neutralized salt, wherein the maleic anhydride is derivatized with a glycol ether, may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some embodiments, the molecular weight of the anti-scalant, e.g., a copolymer of sodium allyl sulfonate and maleic anhydride or its neutralized salt, wherein the maleic anhydride is derivatized with a glycol ether, may be from about 1500 Da to about 5000 Da. In some embodiments, said anti-scalant may comprise a copolymer of sodium allyl sulfonate and maleic anhydride or its neutralized salt, wherein the maleic anhydride is derivatized with a glycol ether, e.g., DEGME, wherein the level of incorporation of the glycol ether is from about 30 mol % to about 60 mol %, further wherein the molecular weight of the anti-scalant is from about 1500 Da to about 5000 Da. In some embodiments, the anti-scalant may reach a desired level of biodegradation after a desired time period, such as, for instance, at least 20% biodegradation after 28 days. In some instances, the degree of biodegradation may be calculated by dividing the observed biochemical oxygen demand (“BOD”) with the theoretical BOD for full degradation of the molecule, which value can either be calculated or measured. In some instances, a sample, e.g., a polymer, may be fully biodegraded when the BOD ceases to change during a biodegradation test, such as those presented in Example 2. As discussed further infra, it was surprisingly found that the biodegradable anti-scalants described herein may comprise an enhanced tolerance for one or more divalent ions, e.g., calcium, e.g., magnesium. For example, the tolerance may in some instances be complete to the solubility limit of calcium chloride in water. Such enhanced divalent ion tolerance, e.g., calcium and/or magnesium tolerance, may be as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%, such as, for example, the tests performed in Example 4 infra. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%.

Moreover the present disclosure generally relates to a method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants, e.g., a copolymer of sodium allyl sulfonate and maleic anhydride or its neutralized salt, wherein the maleic anhydride is derivatized with a glycol ether. In some embodiments, said biodegradable anti-scalant may reach a desired level of biodegradation after a desired time period, such as, for instance, at least 20% biodegradation after 28 days, which in some instances may allow for discharge of a treated fluid into the environment and/or reuse of the treated fluid in one or more additional desired processes and/or may comprise enhanced divalent ion tolerance. In some embodiments, the enhanced divalent ion tolerance may comprise enhanced tolerance to magnesium and/or calcium. In some embodiments, the enhanced tolerance may in some instances be complete to the solubility limit of calcium chloride in water. Such enhanced divalent ion tolerance, e.g., calcium and/or magnesium tolerance, may be as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%, such as, for example, the tests performed in Example 4 infra. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%. In some embodiments, an anti-scalant as described herein, e.g., a copolymer of sodium allyl sulfonate and maleic anhydride or its neutralized salt, wherein the maleic anhydride is derivatized with a glycol ether, may exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%.

In some embodiments, a method for treating or preventing scale may comprise treatment with one or more anti-scalants, e.g., a copolymer of sodium allyl sulfonate and maleic anhydride or its neutralized salt, wherein the maleic anhydride is derivatized with a glycol ether, further wherein said anti-scalants comprise enhanced divalent ion tolerance, e.g., calcium and/or magnesium tolerance.

In some embodiments, a method for treating or preventing scale may comprise treatment with one or more anti-scalants, e.g., a copolymer of sodium allyl sulfonate and maleic anhydride or its neutralized salt, wherein the maleic anhydride is derivatized with a glycol ether, further wherein said anti-scalant may comprise a copolymer of sodium allyl sulfonate and maleic anhydride or its neutralized salt, wherein the maleic anhydride is derivatized with a glycol ether, e.g., DEGME, wherein the level of incorporation of the glycol ether is from about 30 mol % to about 60 mol %, further wherein the molecular weight of the anti-scalant is from about 1500 Da to about 5000 Da, and further wherein the anti-scalant comprise enhanced divalent ion tolerance. In some instances, said one or more anti-scalants may comprise diethylene glycol methyl ether. In some embodiments, the level of incorporation of a glycol ether, e.g., DEGME, in said one or more anti-scalants, e.g., a copolymer of sodium allyl sulfonate and maleic anhydride or its neutralized salt, wherein the maleic anhydride is derivatized with a glycol ether, may be about 10 mol % or less, 10 mol % or more, 20 mol % or more, 30 mol % or more, 40 mol % or more, 50 mol % or more, 60 mol % or more, 70 mol % or more, 80 mol % or more, or 90 mol % or more. In some instances, the level of incorporation of a glycol ether in an anti-scalant, e.g., a copolymer of sodium allyl sulfonate and maleic anhydride or its neutralized salt, wherein the maleic anhydride is derivatized with a glycol ether, optionally DEGME, may be from about 10 mol % to about 60 mol %, from about 20 mol % to about 60 mol %, from about 30 mol % to about 60 mol %, from about 40 mol % to about 60 mol %, from about 50 mol % to about 60 mol %, from about 30 mol % to about 50 mol %, or from about 40 mol % to about 50 mol %.

In some embodiments, methods of treating scale with one or more anti-scalants may prevent, inhibit, reduce, and/or stabilize formation of scale in a fluid of need of treatment and/or prevent, inhibit, reduce or stabilize deposition of said scale, wherein said scale may have resulted from an oil or gas production or recovery process. In some embodiments, methods of treating scale with one or more biodegradable anti-scalants may result in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation as compared to a method which did not comprise treatment with said one or more anti-scalants.

In some embodiments, methods of treating or preventing scale with one or more anti-scalants, e.g., a copolymer of sodium allyl sulfonate and maleic anhydride or its neutralized salt, wherein the maleic anhydride is derivatized with a glycol ether, may comprise adding 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more of said one or more anti-scalants to a fluid in need of treatment.

In some embodiments, one or more anti-scalants for use in the treatment or preventing of scale may be provided in liquid form, e.g., as an aqueous solution. In some embodiments, one or more anti-scalants for use in the treatment of scale may be water-soluble. In some embodiments, one or more anti-scalants for use in the treatment of scale may be provided in dry form and/or powder form. In some embodiments, methods of treating scale with one or more anti-scalants may comprise treatment with one or more anti-scalants, e.g., a copolymer of sodium allyl sulfonate and maleic anhydride or its neutralized salt, wherein the maleic anhydride is derivatized with a glycol ether, whose molecular weight may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some instances, the molecular weight of the anti-scalant, e.g., a copolymer of sodium allyl sulfonate and maleic anhydride or its neutralized salt, wherein the maleic anhydride is derivatized with a glycol ether, may be from about 1500 Da to about 5000 Da.

In some embodiments, addition and/or introduction of one or more anti-scalants in a method for treatment or prevention of scale may be a continuous application or a direct, e.g., intermittent injection of said one or more biodegradable anti-scalants into the process and/or component in need of treatment, e.g., direct injection into a formation in need of treatment. Said application and/or injection may be accomplished using any techniques known and used in the art, especially methods used in oil and gas recovery and treatment of oil and gas deposits and desalination methods. In some embodiments, addition and/or introduction of said one or more anti-scalants may be intermittent addition to the fluid as necessary or desired. In some embodiments, the amount of one or more anti-scalants used to treat scale may be any amount that results in a desired effect, i.e., any desired degree of reduction of scale formation or reduction in the rate of scale formation inhibition, reduction, prevention, and/or control that is desired for a given process.

In some embodiments, methods of treating or preventing scale with one or more biodegradable anti-scalants may occur at any temperature at which a process in need of treatment of scale occurs. For example, the temperature may be atmospheric temperature. In some instances, the temperature may be 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, 100° C. or more, 125° C. or more, or 150° C. or more.

In some embodiments, methods of treating or preventing scale with one or more anti-scalants may occur at any pH at which a process in need of treatment of scale occurs. The one or more anti-scalants described herein may be used in methods for the treatment or prevention of scale in aqueous systems. In some embodiments, a method for treating scale may comprise adding one or more anti-scalants as described herein to an aqueous system in need of scale treatment, in an amount effective to reduce or inhibit scale in the aqueous system. Methods for identifying aqueous systems in need of scale treatment are known to those skilled in the art.

A broad variety of aqueous systems may be treated to reduce scale using the methods described herein. Non-limiting examples of such aqueous systems include boiler water, cooling water, produced water, seawater (e.g., in oil platform applications), brackish water, oilfield water (e.g., topside and/or downhole), coal processing water, and industrial treatment plant water. In some embodiments, a method for treating or preventing scale may comprise adding one or more anti-scalants to oilfield water in need of scale treatment, in an amount effective to reduce or inhibit scale in the oilfield water. For example, the anti-scalants may be added to process water (produced water) on an oil platform. The oilfield water may be downhole water that is pumped underground (e.g., for enhanced oil recovery) and/or may be used to treat topside oilfield water. In some embodiments, methods of treating scale with one or more anti-scalants may comprise treatment of water that is used in and/or results from any part of an enhanced oil recovery process. In some embodiments, methods of treating or preventing scale with one or more anti-scalants may comprise treatment of water that is used in and/or results from any part of a gas recovery or production process. In some embodiments, methods of treating or preventing scale with one or more anti-scalants may comprise treatment of water that is used in and/or results from any part of a mining process. In some embodiments, methods of treating or preventing scale with one or more biodegradable anti-scalants may comprise treatment of water that is used in and/or results from any part of the processing of pulp, paper, and/or cardboard. In some embodiments, methods of treating or preventing scale with one or more anti-scalants may comprise treatment of produced water. In some embodiments, methods of treating or preventing scale with one or more anti-scalants may comprise treating a formation in which scale may form. In some embodiments, methods of treating or preventing scale with one or more anti-scalants may comprise treatment of a fluid in need of treatment, such as any fluid in which scale may form, particularly wherein scale formation is problematic for a process in which the fluid in need of treatment may be used or may be a part of. In some embodiments, methods of treating or preventing scale with one or more anti-scalants may comprise treatment of a fluid in need of treatment, wherein said fluid in need of treatment comprises sulfur-based scale, e.g., iron sulfate and/or iron sulfide and/or zinc sulfide and/or lead sulfide. In some embodiments, a method for treating or preventing scale may comprise adding one or more anti-scalants and one or more corrosion inhibitors to a fluid in need of treatment. Examples of corrosion inhibitors include, but are not limited to, imidazolines, fatty amines, benzotriazole, quinoline, rosin amine, sodium phosphate, silicate, and chromate.

In some embodiments, a method for treating or preventing scale may comprise adding one or more anti-scalants to fluid in need of treatment that may be used in conjunction with topside equipment that may be used in gas and/or oil recovery, such as equipment for separation of water and oil. For example, in such topside equipment, formation of scale, e.g., sulfur-based scale, may interfere with the separation of water and oil in said equipment as said scale may promote formation of an emulsified oil and water layer in said equipment.

In some instances, after brine comes to saturation, scale may begin to form and plug production lines, filters, pumps, and/or screens, for example, and treatment with one or more biodegradable anti-scalants may reduce the occurrence or severity of, prevent, and/or eliminate such events from occurring. Furthermore, methods of treating or preventing scale with one or more anti-scalants may be used in conjunction with any process that may involve formation of brine in which scale may form and may plug production lines, filters, pumps, and/or screens. In some embodiments, methods of treating or preventing scale with one or more anti-scalants may prevent and/or reduce plugging of a fluid conduit disposed in an injection wellbore. In some embodiments, methods of treating or preventing scale with one or more anti-scalants may prevent and/or reduce plugging of a subterranean formation. In some embodiments, methods of treating or preventing scale with one or more anti-scalants may prevent and/or reduce plugging of a production well and/or components associated with a production well.

Furthermore, in some embodiments, methods of treating or preventing scale with one or more anti-scalants may comprise addition of said one or more anti-scalants to a circulating fluid. In some embodiments, the circulating fluid is utilized in, or is a component of, a mining process, or is in a system that is utilized in a mining process. In some embodiments, the circulating fluid is utilized in, or is a component of, a pulp, paper, and/or cardboard-related process, or is in a system that is utilized in the processing of pulp, paper, and/or cardboard. In some embodiments, the circulating fluid is utilized in, or is a component of, an oil and gas exploration or production process, or is in a system that is utilized in an oil and gas exploration and production process. In some embodiments, the circulating fluid is utilized in, or is a component of, coal processing, or is in a system that is utilized in coal processing (e.g., coal slurry transport).

In some embodiments, methods of treating or preventing scale with one or more anti-scalants may comprise addition of said one or more anti-scalants to a brackish water and/or seawater. For example, the anti-scalant may be added to the process water of a desalination plant. In some embodiments, the brackish water and/or seawater may scale comprising calcium carbonate.

In some embodiments, methods of treating or preventing scale with one or more anti-scalants may comprise addition of said one or more anti-scalants to an oilfield water. For example, the anti-scalant may be added to process water on an oil platform. The oilfield water may be downhole water that is pumped underground (e.g., for enhanced oil recovery) and/or may be used to treat topside oilfield water. In some embodiments, the oilfield water may comprise scale comprising a sulfate salt, e.g., barium sulfate and/or strontium sulfate.

In some embodiments, methods of treating or preventing scale with one or more anti-scalants may comprise addition of said one or more anti-scalants to municipal treatment plant water. For example, the anti-scalant may be added to the process water of a plant that treats water to render it suitable for municipal drinking water, and/or to a plant that treats municipal wastewater. In some embodiments, the municipal treatment plant water may comprise scale comprising a phosphate, e.g., at least one of struvite and vivianite.

Moreover, the present disclosure generally relates to a composition suitable for use in the treatment of scale comprising one or more anti-scalants and a fluid in need of treatment, i.e., a fluid in which scale may form, such as, for example, produced water resulting from any of the industrial processes described herein or known in the art, optionally wherein said one or more anti-scalants comprise a copolymer of sodium allyl sulfonate and maleic anhydride or its neutralized salt, wherein the maleic anhydride is derivatized with a glycol ether. In some embodiments, a composition suitable for use in the treatment of scale may comprise (i) an effective amount of one or more anti-scalants, wherein said one or more anti-scalants comprise a copolymer of sodium allyl sulfonate and maleic anhydride or its neutralized salt, wherein the maleic anhydride is derivatized with a glycol ether, and (ii) optionally a fluid in need of treatment.

In some embodiments, said anti-scalant may comprise a copolymer of sodium allyl sulfonate and maleic anhydride or its neutralized salt, further wherein the maleic anhydride is derivatized with one or more glycol ethers. Such glycol ethers include, but are not limited to, ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether. In some embodiments, said anti-scalant may comprise diethylene glycol methyl ether. In some embodiments, the level of incorporation of a glycol ether in said anti-scalant, e.g., a copolymer of sodium allyl sulfonate and maleic anhydride or its neutralized salt, wherein the maleic anhydride is derivatized with a glycol ether, may be about 10% or less, 10% or more, 20% or more, 30% or more, 40% or more, 50% or more, 60% or more, 70% or more, 80% or more, or 90% or more. In some instances, the level of incorporation of a glycol ether in said anti-scalant, e.g., a copolymer of sodium allyl sulfonate and maleic anhydride or its neutralized salt, wherein the maleic anhydride is derivatized with a glycol ether, may be from about 10% to about 60%, from about 20% to about 60%, from about 30% to about 60%, from about 40% to about 60%, from about 50% to about 60%, from about 30% to about 50%, or from about 40% to about 50%. In some embodiments, the molecular weight of the anti-scalant, e.g., a copolymer of sodium allyl sulfonate and maleic anhydride or its neutralized salt, wherein the maleic anhydride is derivatized with a glycol ether, may be about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more. In some instances, the molecular weight of the anti-scalant, e.g., a copolymer of sodium allyl sulfonate and maleic anhydride or its neutralized salt, wherein the maleic anhydride is derivatized with a glycol ether, may be from about 1500 Da to about 5000 Da. In some embodiments, said anti-scalant may comprise a copolymer of sodium allyl sulfonate and maleic anhydride or its neutralized salt, wherein the maleic anhydride is derivatized with a glycol ether, e.g., DEGME, wherein the level of incorporation of the glycol ether is from about 30% to about 60%, further wherein the molecular weight of the anti-scalant is from about 1500 Da to about 5000 Da. In some embodiments, the anti-scalant may demonstrate a high degree of tolerance for one or more divalent ions, e.g., calcium, e.g., magnesium. In some embodiments, the anti-scalant may reach a desired level of biodegradation after a desired time period, such as, for instance, at least 20% biodegradation after 28 days and/or may comprise enhanced divalent ion tolerance. In some embodiments, said anti-sealants comprise enhanced divalent ion tolerance, e.g., calcium and/or magnesium tolerance. For instance, such enhanced divalent ion tolerance, e.g., calcium and/or magnesium tolerance, may be determined by measuring the percent transmission of test solutions comprising the one or more anti-scalants and varying concentrations of divalent ion(s) and comparing the percent transmission of these test solutions to test solutions which either had no anti-scalant added or to other anti-scalants or anti-scalants, for example, the tests performed in Example 4 infra.

In some embodiments, said fluid in need of treatment may comprise a circulating fluid, such as, but not limited to, a circulating fluid utilized in, or is a component of, a mining process, or is in a system that is utilized in a mining process; a circulating fluid utilized in, or is a component of, a pulp, paper, and/or cardboard-related process, or is in a system that is utilized in a pulp, paper, and/or cardboard-related process; a circulating fluid is utilized in, or is a component of, an oil and gas exploration or production process, or is in a system that is utilized in an oil and gas exploration and production process; or a circulating fluid is utilized in, or is a component of, coal processing, or is in a system that is utilized in coal processing (e.g., coal slurry transport).

In some embodiments, said fluid in need of treatment may comprise fluid used in any process or part of a process involved in such process as, but not limited to, a mining process, or a system that is utilized in a mining process; the processing of pulp, paper, and/or cardboard; an oil and gas exploration or production process, or an oil and gas exploration and production process; or coal processing, or is in a system that is utilized in coal processing (e.g., coal slurry transport). In some embodiments, a fluid in need of treatment may comprise produced water. In some embodiments, a fluid in need of treatment may comprise a fluid in which scale, e.g., sulfur-based scale such as iron sulfide, zinc sulfide, and/or lead sulfide, may form, particularly wherein scale formation is problematic for a process in which the fluid in need of treatment may be used or may be a part of.

In some embodiments, said fluid in need of treatment may comprise hydrogen sulfide that may, due to the conditions in which said fluid in need of treatment is present, serve as a precursor for formation of a sulfur-based scale, such as iron sulfide and/or zinc sulfide and/or lead sulfide, wherein such scale may precipitate. In some embodiments, said fluid in need of treatment comprises boiler water, cooling water, seawater (e.g., in oil platform applications), brackish water, oilfield water (e.g., topside and/or downhole), coal processing water, or industrial treatment plant water.

In some embodiments, said fluid in need of treatment may comprise oilfield water in need of treatment, i.e., in which scale, e.g., sulfur-based scale may form. In some embodiments, said fluid in need of treatment may comprise downhole water that is pumped underground (e.g., for enhanced oil recovery). In some embodiments, said fluid in need of treatment may comprise topside oilfield water. In some embodiments, said fluid in need of treatment may comprise any fluid resulting from any part of a process associated with enhanced oil recovery. In some embodiments, said fluid in need of treatment may comprise produced water. In some embodiments, said fluid in need of treatment may comprise water that is used in and/or results from any part of a gas recovery process.

In some embodiments, said fluid in need of treatment may comprise water that is used in and/or results from any part of a process associated with a low cut gas well. In some embodiments, said fluid in need of treatment may comprise water that is used in and/or results from any part of a mining process. In some embodiments, said fluid in need of treatment may comprise water that is used in and/or results from any part of the processing of pulp, paper, and/or cardboard.

The compositions and methods illustratively disclosed herein suitably may be practiced in the absence of any element which is not specifically disclosed herein and/or any element specifically disclosed herein.

### EXAMPLES

### Example 1—Biodegradable Anti-Scalant Synthesis

In the present example, synthesis of exemplary biodegradable anti-scalants prepared for use in the various tests described infra is described.

First, a glycol ether, such as diethylene glycol methyl ether, was charged to a round bottom flask equipped with a heating mantle. Mixing was started, and then maleic anhydride was charged to the round bottom flask. The mixture was heated to 80° C., and samples of the mixture were taken until the acid value reached a desired value. The acid value was determined by titration of the mixture with a base (sodium hydroxide) to a specific pH value. The desired value was calculated based on the weights of acid and glycol used. Once the desired acid value was reached, the round bottom flask was charged with water and sodium allyl sulfonate in desired amounts. A condenser was then attached, and the mixture was heated to reflux. Separately, a solution of ammonium persulfate in water was prepared, and a pump was set up to deliver the ammonium persulfate and water to the round bottom flask. The pump was then used to charge the ammonium persulfate solution to the round bottom flask over a 3 hour time period.

Following the 3 hour time period, ammonium persulfate was charged to the round bottom flask while maintaining reflux, and after the ammonium persulfate was charged to the flask, the solution was mixed for an additional hour under reflux. Following the hour long mixing period, the mixture was cooled, and samples of the mixture were taken to analyze the solids content and residual monomer. For example, residual SAS and/or maleic anhydride monomers were measured using ion chromatography. If necessary, adjustment of the solids was made with water, and, if necessary, additional ammonium persulfate was added to reduce monomer content. For example, in some instances when the residual monomer content is 1% or greater, additional persulfate was added. Example charge amounts of components used for synthesizing exemplary anti-scalants are presented in Table 1 below. Water was charged twice: once to dissolve the monomers and once to dissolve the ammonium persulfate.

TABLE 1

| Component | Charge Amount (weight) |
|---|---|
| Maleic anhydride | 49.74 |
| DEGME | 24.38 |
| Sodium allyl sulfonate | 75.88 |
| Water | 159.30 |
| Water | 22.57 |
| Ammonium persulfate | 8.05 |

Examples of exemplary anti-scalant compositions used throughout the examples are presented in Table 2.

TABLE 2

| | | Weight of | Weight of | Weight of | Weight of | Weight of |
|---|---|---|---|---|---|---|
| | Weight of | Component | Component | Component | Component | Component |
| | Component | for | for | for | for | for |
| | for 2% | 10% | 30% | 40% | 50% | 100% |
| | DEGME | DEGME | DEGME | DEGME | DEGME | DEGME |
| | anti- | anti- | anti- | anti- | anti- | anti- |
| Component | scalant (g) | scalant (g) | scalant (g) | scalant (g) | scalant (g) | scalant (g) |
| SAS | 89.73 | 86.41 | 79.09 | 75.88 | 72.92 | 61.01 |
| Water | 188.38 | 181.41 | 166.04 | 159.30 | 153.08 | 128.07 |
| NaCl | 33.47 | 32.23 | 29.5 | 28.3 | 27.2 | 22.76 |
| Maleic | 57.65 | 50.98 | 32.69 | 29.85 | 23.9 | 0 |
| Anhydride | | | | | | |
| DEGME/Maleic | 2.62 | 12.6 | 34.61 | 44.27 | 53.18 | 88.99 |
| EDTA | 1.33 | 1.28 | 1.17 | 1.12 | 1.08 | 0.9 |
| Ammonium | 9.52 | 9.17 | 8.39 | 8.05 | 7.74 | 6.47 |
| persulfate | | | | | | |
| Water | 9.52 | 9.17 | 8.39 | 8.05 | 7.74 | 6.47 |

### Example 2—Biodegradation Tests

In this example, the biodegradation of various different anti-scalant composition samples prepared in accordance with Example 1 was evaluated by dissolving an amount of a given composition into a water sample containing active bacteria, e.g., bacteria native to a given water source, such as surface water from a creek or lake or seawater, capable of degrading the material under aerobic conditions. The bacteria that were present in each sample used oxygen for metabolism, and the carbon dioxide generated by the bacteria was absorbed by 100% sodium hydroxide pellets placed in a holder. The consumption of oxygen was measured by the decrease in pressure in the flask by an OxiTop measuring head, as described below, and pressure decreases were indicative of the biodegradability of the sample under evaluation.

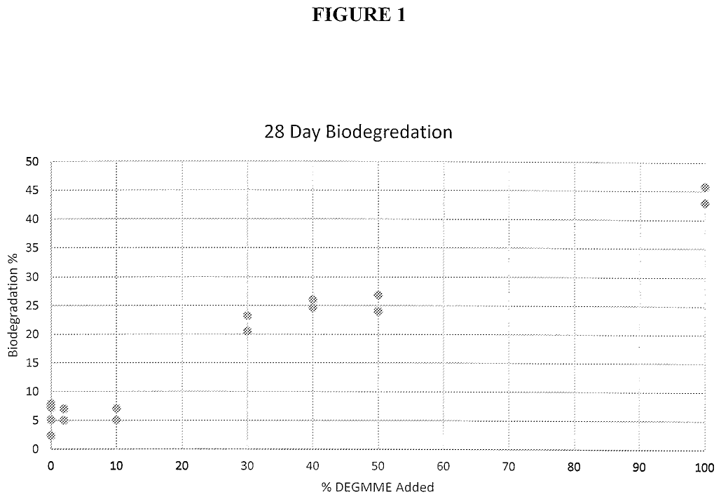

More specifically, compositions comprising exemplary biodegradable anti-scalants which comprised polymers comprising monomers of sodium allyl sulfonate and maleic anhydride which were derivatized with varying amounts of diethylene glycol methyl ether (DEGME) were compared to compositions comprising polymers comprising monomers of sodium allyl sulfonate and maleic anhydride that were not derivatized with a glycol ether (see FIG. 1). The biodegradation tests were performed as generally described by the OECD guidelines for testing of chemicals, specifically test #306: Biodegradability in Seawater (adopted 17 Jul. 1992), which is hereby incorporated by reference in its entirety.

Samples for the biodegradation tests were prepared by first calculating the theoretical oxygen demand for each of the compositions to be tested (calculation as described in OECD 306 procedure). Based on the theoretical oxygen demand, a solution of a given composition was prepared according to Table 3.

TABLE 3

| | Measuring | Drops of |
|---|---|---|
| Volume | Range | Nitrification |
| (ml)/bottle | mg O₂/L | Inhibitor (if used) |
| 432 | 0-40 | 9 |
| 365 | 0-80 | 7 |
| 250 | 0-200 | 5 |
| 164 | 0-400 | 3 |
| 97 | 0-800 | 2 |
| 43.5 | 0-2000 | 1 |
| 22.7 | 0-4000 | 1 |

Once the solution according to Table 3 was prepared, the volume of solution was added to an OxiTop sample bottle and a magnetic stir bar was added. A rubber stopper was placed in the neck of the flask and 2 tablets of sodium hydroxide were added. The OxiTop measuring sensor was then tightly screwed onto the sample bottle, and measurement was started using an OxiTop controller. The samples were placed on the stirring platform, and the stirring system was switched on once all of the bottles containing the different samples were placed on the stirring platform. The test was then run for a desired length of time (28 days in the present example). The measurement values were read by the OxiTop controller, and the measured values were entered into a datasheet.

Referring now to FIG. 1, the 28 day biodegradation test of various different compositions comprising anti-scalants were evaluated and calculated as described by the procedures in OECD 306, i.e., by dividing the observed biochemical oxygen demand (“BOD”) by the Theoretical Oxygen Demand (ThOD). Biodegradable anti-scalant compositions tested for generating the data of FIG. 1 included compositions comprising a biodegradable anti-sealant comprising a copolymer of sodium allyl sulfonate and maleic anhydride derivatized with DEGME in varying amounts (0%, 10%, 30%, 40%, 50%, and 100%). As can been observed in FIG. 1, anti-scalants comprising 30% DEGME or more reached at least 20% biodegradation by day 28.

### Example 3—Scale Treatment

In the present example, dynamic tube-blocking experiments were performed to evaluate scale treatment using various different anti-scalants.

First, the following cationic and anionic scaling solutions were prepared:

TABLE 4

| | |
|---|---|
| Hydrate | g/L |

| | H2O | Cationic | Anionic |
|---|---|---|---|
| Sodium chloride | 0 | 38.638 | 35.036 |
| Potassium chloride | 0 | 0.958 | 0.958 |
| Magnesium chloride | 6 | 6.830 | 6.830 |
| Calcium chloride | 2 | 5.311 | 0.000 |
| Strontium chloride | 6 | 0.441 | 0.000 |
| Barium chloride | 2 | 0.507 | 0.000 |
| Sodium sulfate | 0 | 0.000 | 4.377 |
| Sodium bicarbonate | 0 | 0.000 | 0.000 |

Next, a following buffer solution as described in Table 5 was prepared:

TABLE 5

13.60 g sodium
acetate
trihydrate
1 drop acetic
acid
DI water to 100
mL

2 mL of buffer were added per 100 mL of brine (same cationic brine solution listed in the first column of Table 4) prior to fully diluting. Next, an anti-scalant solution was prepared by diluting 1.000 gram of an anti-scalant prepared as generally described in Example 1 in 1 L of brine. The dynamic scale loop was then set up with the following conditions: temperature—85° C.; pressure—1000 PSI; Flow—5 mL/min each of cationic and anionic; cleaning—5% EDTA pH>12 at 5 ml/min for 10 minutes followed by DI Water 5 ml/min for 5 min.

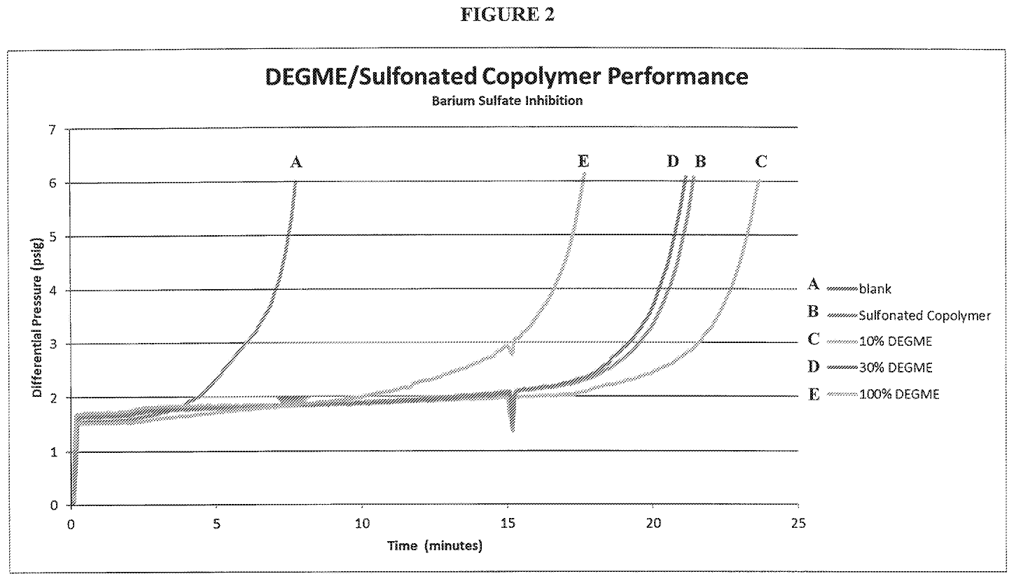

A blank sample was run with no anti-scalant to determine the blank scaling time at which scale formed in the coil as indicated by a rise in the differential pressure. Following the blank sample run, the column was cleaned using the above-mentioned cleaning protocol, and then the anti-scalant was run through the loop at each tested concentration level (10 mg/L for the first 15 minutes, them 7.5 mg/L) for an amount of time at least double the blank sample testing time. During each test run, the anti-scalant concentration was reduced until the scale coil differential pressure reached the desired value. The lowest anti-scalant concentration which prevented scale formation the scaling coil was reported as the minimum effective dosage (MED) for the scale inhibitor. (The MED values for all in FIG. 2 are 10 mg/L except the 100% DEG which failed at that level, so MED>10 mg/L).

In FIG. 2 exemplary anti-scalants comprising a copolymer comprising sodium allyl sulfonate and maleic anhydride, which maleic anhydride was derivatized with varying amounts of diethylene glycol methyl ether (DEGME) (10 mol %, 30 mol %, and 100 mol % derivatization), were tested and compared to an anti-scalant composition comprising a sulfonated copolymer (maleic anhydride/SAS copolymer with no added MEG).

The brine solution referenced in Table 4 above is a brine solution wherein “barium sulfate” forms as a result of the barium in the cationic solution forming barium sulfate scale with the sulfate in the anionic solution. As can be seen from the results in FIG. 2 various anti-scalants according to the invention reduced scale. In the figure performance is indicated by the amount of time before the pressure increases, which indicates that scale is forming and blocking the scaling coil. As can be seen from the results in the figure formulations B, C, and D all provided similar performance, while formulation E yielded lower performance.

### Example 4—Divalent Ion Tolerance Tests

In the present example, the divalent cation tolerance of various different anti-scalant compositions, including biodegradable anti-scalant compositions, was evaluated. In particular, the various different compositions were evaluated for calcium and magnesium tolerance, as described further infra.

First, a brine comprising 157 grams of NaCl in 1000 ml of DI water was prepared at 60° C., and the pH was adjusted to 6 using 0.1 M NaOH or HCl as needed. and the temperature and pH of the brine was adjusted to the desired temperature and pH. Next, the composition to be evaluated was added to the brine at a desired concentration. Separately, a control brine sample was made by preparing a brine sample at the same temperature and pH but without addition of compositions that comprised one or more anti-scalants. The control brine sample was then used to zero the turbidity of the spectrophotometer used in the present example (Hach DR 500 Spectrophotometer). Following preparation of the solutions and spectrophotometer, a calculated quantity of divalent ions, such as one of those quantities present in Table 6, was added to the test solution and the control solution in the form of a divalent salt (calcium chloride or magnesium chloride) while mixing the solution. In general, 3.668 grams of CaCl₂) 2H₂O were added to increase the calcium ion concentration by 1000 mg/L. Following a desired mixing time, i.e., such an amount of time that the solution was mixed until the clarity of the solution was stabilized, generally about 10-15 minutes, a spectrophotometer cuvette was filled with either the control solution or one of the test solutions, and the turbidity was measured and recorded. Subsequent measurements were obtained by adding more divalent salt to the control and test solutions, and, following mixing, taking turbidity measurements. The limit of tolerance (sometimes referred to as compatibility) was recorded as the highest concentration of the divalent salt(s) added that resulted in a clear solution, and further recorded as an 80% transmission value as measured by the spectrophotometer (Hach DR 500 Spectrophotometer measuring at a wavelength of 420 nm). Representative concentrations of cation, e.g., calcium, e.g., magnesium, following each divalent salt addition was as presented in Table 6.

TABLE 6

| | CaCl₂ 2H₂O | |
|---|---|---|
| Concentration of Cation (mg/L) | (g/L) | MgCl₂ 6H₂O |
| 500 | 1.834 | 4.182 |
| 1,000 | 3.668 | 8.365 |
| 2,000 | 7.336 | 16.730 |
| 5,000 | 18.340 | 41.825 |
| 10,000 | 36.681 | 83.649 |
| 20,000 | 73.362 | 167.299 |

A calcium tolerance test was performed as generally described above. The tests were performed at 60° C. using 1000 ppm of each of the following compositions: diethylenetriamine penta(methylene phosphonic acid) (“DTPMP”); sulfonated copolymer (a commercially available anti-scalant); a biodegradable anti-scalant comprising copolymer of sodium allyl sulfonate and maleic anhydride derivatized with 40% DEGME; a biodegradable anti-scalant comprising a copolymer of sodium allyl sulfonate and maleic anhydride derivatized with 50% DEGME; and a biodegradable anti-scalant comprising a copolymer of sodium allyl sulfonate and maleic anhydride derivatized with 100% DEGME.

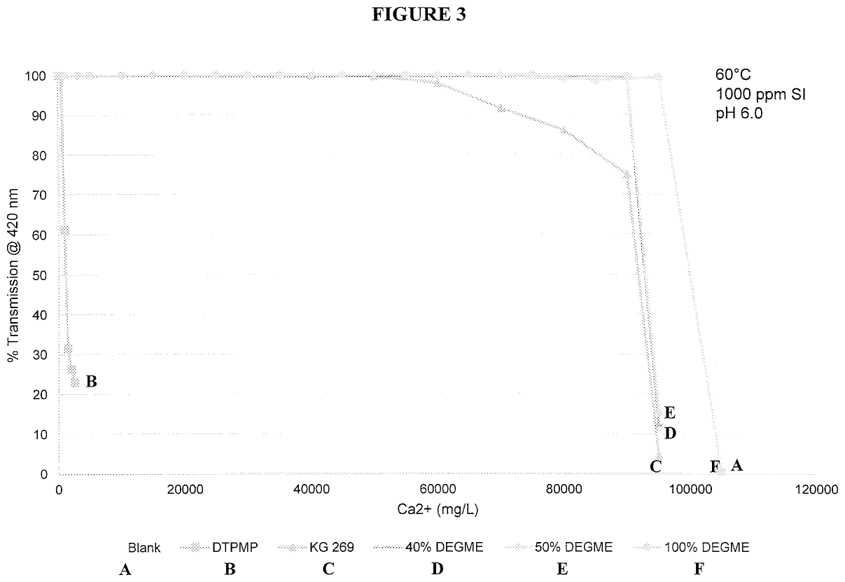

As can be seen from FIG. 3, it was observed that compositions comprising exemplary biodegradable anti-scalants, i.e., those comprising a copolymer of sodium allyl sulfonate and maleic anhydride derivatized with DEGME, performed better than other anti-scalant compositions evaluated. In particular, compositions comprising DEGME at either 40% or 50% demonstrated a high degree of calcium tolerance as the percent transmission of the samples was higher than that of samples of other compositions for a given amount of calcium ions (see FIG. 3). In particular, compositions comprising 40% DEGME demonstrated tolerance (as measured by at least 80% transmission) of up to 90,000 mg/L (PPM) calcium ions, and compositions comprising 50% DEGME demonstrated tolerance (as measured by at least 80% transmission) of up to ×92,000 mg/L (PPM) calcium ions.

A magnesium tolerance test was performed as generally described above. The tests were performed at 60° C. using 1000 ppm of each of the following compositions: sulfonated copolymer (commercially available anti-scalant), a biodegradable anti-scalant comprising a copolymer of sodium allyl sulfonate and maleic anhydride derivatized with 40% DEGME; and a biodegradable anti-scalant comprising a copolymer of sodium allyl sulfonate and maleic anhydride derivatized with 50% DEGME.

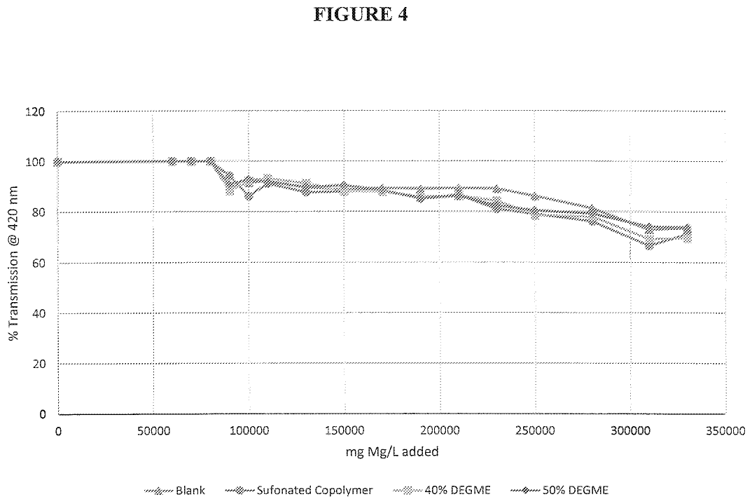

Additionally, as shown in FIG. 4, it was observed that compositions comprising exemplary biodegradable anti-scalants, i.e., those comprising a copolymer of sodium allyl sulfonate and maleic anhydride derivatized with DEGME, performed better than other anti-scalant compositions evaluated. In particular, compositions comprising biodegradable anti-scalants comprising DEGME at either 40% or 50% demonstrated a high degree of magnesium tolerance as the percent transmission of the samples was higher than that of samples of other compositions for a given amount of magnesium ions (see FIG. 4). In particular, compositions comprising 40% DEGME demonstrated tolerance (as measured by at least 80% transmission) of up to about 250,000 mg/L (PPM) magnesium ions, and compositions comprising 50% DEGME demonstrated tolerance (as measured by at least 80% transmission) of up to about 250,000 mg/L magnesium ions.

In the preceding procedures, various steps have been described. It will, however, be evident that various modifications and changes may be made thereto, and additional procedures may be implemented, without departing from the broader scope of the exemplary procedures as set forth in the claims that follow.

### Example 5—Additional Biodegradation Tests

In this example, the biodegradation of two different anti-scalant composition samples prepared in accordance with Example 1 was evaluated by dissolving an amount of a given composition into a water sample containing active bacteria, e.g., bacteria native to a given water source, such as surface water from a creek or lake or seawater, capable of degrading the material under aerobic conditions. This method employed no separate bacterial inoculum and relied upon populations of bacteria which occurred naturally in seawater.

Raw seawater was supplied by a submersible pump situated in Scapa Flow, Orkney, Scotland. The raw seawater was pre-treated to remove coarse particles by filtration through a 45 μm filter into a tank and aged under aerobic condition in the dark for five to ten days before use. The collected seawater was fortified with mineral nutrients prior to test commencement.

Biodegradation tests were performed as generally described by the OECD guidelines for testing of chemicals, specifically test #306: Biodegradability in Seawater—Closed Bottle Method (adopted 17 Jul. 1992), which is hereby incorporated by reference in its entirety.

Overall assessment of biodegradability was based upon comparison between the experimentally determined oxygen consumption (BOD measurements) and the oxygen consumption predicted if all carbon present in the test material was completely oxidized (100% BOD); derived from theoretical oxygen demand (ThOD) multiplied by the addition rate (e.g., 10 mg sample/L). The ThOD in mg of oxygen per mg of test substance was calculated for each of the compositions to be tested as described in OECD 306 procedure.

The concentration of test material added to the test vessels was in the range of 2-10 mg of test substance per liter of test medium. The size of glass BOD bottles used were 260 to 280 ml. Three replicates per time-point were set up. At 20° C., the minimum dissolved oxygen saturation value upon test initiation at normal atmospheric pressure was 7 mg/l. The bacteria that were present in each sample consumed oxygen during metabolism. Luminescent dissolved oxygen was measured at 7-day intervals over 28 days using a Luminescent dissolved oxygen meter (Hach HQ40d) and probe (Hach LDO10101).

Oxygen consumption in test material vessels was corrected for any oxygen consumption recorded in blank vessels. Barometric pressure was automatically corrected using the luminescent dissolved oxygen probe. The ready degradation of the test material was estimated from the theoretical oxygen consumption if 100% of the material were fully mineralized during the test (calculated from the theoretical oxygen demand and the amount added to the test vessel using the formula % biodegradation=[(mg Oxygen consumed/mg test material)/(mg ThOD/mg test material)]×100).

Samples for biodegradation tests were prepared by first dissolving 1 g of test sample in 1 L of deionized water and then diluting 50 mL of the resulting stock solution into a 5 L flask of nutrient enriched seawater. Test conditions are listed in Table 7.

TABLE 7

| Test condition | Details | | |
|---|---|---|---|
| Test duration | 28 days | | |
| Bottle temperature when | 20° C. ± 1° C. | | |
| measuring dissolved oxygen | | | |
| Seawater oxygen blank | Measurement of background oxygen | | |
| | consumption in test medium | | |
| Soluble reference material | Sodium benzoate | | |
| | 2 mg/l test concentration, ThOD = | | |
| | 1.66 mgO₂/mg | | |
| Inhibition test | Mixture of sodium benzoate (2 mg/l) and | | |
| | test material (10 mg/l) | | |
| Seawater enrichment stocks | A. | KH₂PO₄ | 8.5 |
| (g/l); 1 L of medium | | K₂HPO₄ | 21.75 |
| contains 1 ml each of stocks | | Na₂HPO₄•2H₂O | 33.3 |
| A, B, C & D | | NH₄Cl | 0.5 |
| | B. | CaCl₂ | 27.5 |
| | C. | MgSO₄•7H₂O | 22.5 |
| | D. | FeCl₃•6H₂O | 0.25 |
| | | EDTA, di-Sodium | 0.4 |

| | |
|---|---|
| Microbial count using the | A minimum of 1.0 × 10¹ to 1.0 × 10³ |
| spread plate method | colony forming units per ml of sea water |

Biodegradation of test material compositions comprising exemplary biodegradable anti-scalants which comprised polymers comprising monomers of sodium allyl sulfonate and maleic anhydride which were derivatized with varying amounts of diethylene glycol methyl ether (DEGME) with active product test concentrations of 39.6% (Test Material 1; 3.96 mg/l test concentration) and 40.6% (Test Material 2; 4.06 mg/l test concentration) were compared to compositions comprising a readily degradable soluble reference material (sodium benzoate; 2 mg/l test concentration), which was used to provide confirmation of the viability of the naturally occurring seawater bacterial population. ThOD values for test materials 1 and 2 were calculated to be 0.425 and 0.448 mgO₂/mg, respectively.

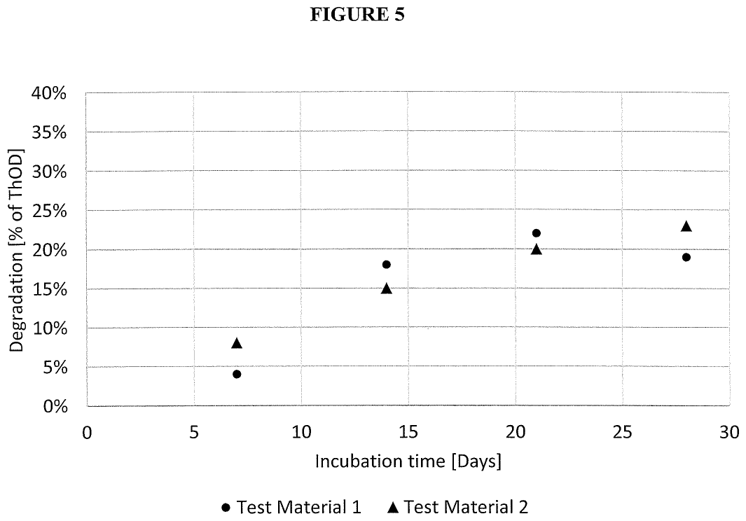

The degree of biodegradability of test materials and the readily degradable soluble reference material was determined over a 28-day incubation period (see FIG. 5) according to the Offshore Chemical Notification Scheme (OCNS) classification table (CEFAS 2014 Hazard Assessment available at <https://www.cefas.co.uk/data-and-publications/ocns/hazard-assessment-process/>[27 Mar. 2020]).

Mean dissolved oxygen and blank oxygen demand (BOD) of enriched seawater was assessed and BOD results are presented in Table 8.

TABLE 8

| Day | Mean dissolved oxygen (mg/l) | Mean BOD (mg/l) | BOD (%) |
|---|---|---|---|
| 0 | 7.50 | — | — |
| 7 | 6.94 | 0.56 | 7 |
| 14 | 6.82 | 0.68 | 9 |
| 21 | 6.70 | 0.80 | 11 |
| 28 | 6.28 | 1.22 | 16 |

The degree of biodegradability of the readily degradable soluble reference material in seawater was assessed and percentage biodegradation results are presented in Table 9.

TABLE 9

| | 100% BOD | | | | |
|---|---|---|---|---|---|
| Material | (mg/l ThOD) | Day 7 | Day14 | Day 21 | Day 28 |
| Sodium benzoate | 3.32 | 69% | 72% | 77% | 72% |

To enable assessment of potential inhibitory effects of each test material (or its primary degradation products) on seawater bacteria, an inhibition experiment was performed, in which a mixture of the readily degradable soluble reference material and the test material was tested. Inhibition was inferred if the extent of degradation in the inhibition control of the mixture was less than the sum of the independent extents of degradation for independently measured test material and readily degradable soluble reference material.

Biodegradation of mixtures of the readily degradable soluble reference material and the test material in seawater was assessed, and percentage biodegradation results are presented in Table 10.

TABLE 10

| | 100% BOD | | | | |
|---|---|---|---|---|---|
| Material | (mg/l ThOD) | Day 7 | Day14 | Day 21 | Day 28 |
| Test Material 1 + | 7.57 | 34% | 39% | 47% | 43% |
| sodium benzoate | | | | | |
| Test Material 2 + | 7.80 | 38% | 41% | 43% | 41% |
| sodium benzoate | | | | | |

Potential inhibition of seawater bacteria by test materials was determined and percentage inhibition results are presented in Table 11. Results indicate minimal inhibition of seawater bacteria (i.e., less than 10%) for test materials.

TABLE 11

| | | Test | Sodium | Sum of | Inhibition | |
|---|---|---|---|---|---|---|
| Test | | material | benzoate | separate BODs | control BOD | Percentage |
| Material | Day | BOD (mg/l) | BOD (mg/l) | (mg/l) | (mg/l) | inhibition |
| 1 | 7 | 0.17 | 2.29 | 2.46 | 2.58 | −5 |
| 1 | 14 | 0.74 | 2.38 | 3.12 | 2.93 | 6 |
| 1 | 21 | 0.93 | 2.56 | 3.49 | 3.52 | −1 |
| 1 | 28 | 0.78 | 2.40 | 3.18 | 3.28 | −3 |
| 2 | 7 | 0.37 | 2.29 | 2.66 | 2.95 | −11% |
| 2 | 14 | 0.65 | 2.38 | 3.02 | 3.20 | −6% |
| 2 | 21 | 0.91 | 2.56 | 3.47 | 3.35 | 4% |
| 2 | 28 | 1.02 | 2.40 | 3.42 | 3.19 | 7% |

Referring now to FIG. 5, the 28-day biodegradation test of two different compositions comprising anti-scalants were evaluated and calculated as described by the procedures in OECD 306, i.e., by dividing the observed biochemical oxygen demand (“BOD”) by the Theoretical Oxygen Demand (ThOD). Biodegradable anti-scalant compositions tested for generating the data of FIG. 5 included compositions comprising a biodegradable anti-scalant comprising a copolymer of sodium allyl sulfonate and maleic anhydride derivatized with DEGME (e.g., Test Materials 1 and 2). As can been observed in FIG. 5, anti-scalants comprising Test Materials 1 and 2 reached at least 20% biodegradation by day 21.

1. An anti-scalant composition comprising a copolymer of sodium allyl sulfonate and maleic anhydride or its neutralized salt, wherein the maleic anhydride is derivatized or reacted with one or more glycol ethers, optionally diethylene glycol methyl ether.

2. The anti-scalant composition of claim 1, further comprising a fluid in need of treatment.

3. The anti-scalant composition of claim 1 or claim 2, wherein said anti-scalant composition:
i. exhibits enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%;
ii. exhibits a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or
iii. exhibits a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%;
wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

4. The anti-scalant composition of any one of the foregoing claims, wherein said anti-scalant composition is capable of reaching a level of at least 20% biodegradation 28 days after introduction into said fluid in need of treatment.

5. The anti-scalant composition of any one of the foregoing claims, wherein:
i. said maleic anhydride is derivatized with one or more glycol ethers selected from the group consisting of ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether;
ii. said maleic anhydride is derivatized with diethylene glycol methyl ether (DEGME);
iii. the level of incorporation of the glycol ether in said anti-scalant is about 10% or less, 10% or more, 20% or more, 30% or more, 40% or more, 50% or more, 60% or more, 70% or more, 80% or more, or 90% or more;
iv. the level of incorporation of the glycol ether in said anti-scalant is from about 10% to about 60%, from about 20% to about 60%, from about 30% to about 60%, from about 40% to about 60%, from about 50% to about 60%, from about 30% to about 50%, or from about 40% to about 50%;
v. the molecular weight of said anti-scalant is about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more;
vi. the molecular weight of the anti-scalant is from about 1500 Da to about 5000 Da;
vii. the maleic anhydride is derivatized with a glycol ether, optionally DEGME; the level of incorporation of the glycol ether is from about 30% to about 60%; and the molecular weight of the anti-scalant is from about 1500 Da to about 5000 Da;
viii. the anti-scalant exhibits enhanced divalent ion tolerance, optionally wherein said divalent ions comprise calcium and/or magnesium;
ix. the anti-scalant comprises enhanced divalent ion tolerance, wherein said divalent ions comprise calcium and/or magnesium;
x. the ratio of sodium allyl sulfonate:maleic anhydride is from about 0.1:99.9 to 99.9:0.1; and/or
xi. the amount of said anti-scalant is 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

6. The anti-scalant composition of any one of claims 2-5, wherein the fluid in need of treatment:
i. comprises a circulating fluid, optionally wherein said circulating fluid comprises any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or in a system that is utilized in coal processing (e.g., coal slurry transport);
ii. comprises fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport);
iii. comprises one or more types of scale, optionally wherein said scale comprises insoluble substances such as insoluble salts, including without limitation sulfate, carbonate and phosphate salts such as calcium carbonate, calcium sulfate, calcium phosphate, barium sulfate, strontium sulfate, vivianite, iron sulfide, zinc sulfide, lead sulfide, and struvite;
iv. comprises boiler water, cooling water, seawater (e.g., in oil platform applications), brackish water, oilfield water (e.g., topside and/or downhole), coal processing water, or industrial treatment plant water;
v. comprises oilfield water in need of treatment;
vi. comprises downhole water that is pumped underground (e.g., for enhanced oil recovery);
vii. comprises topside oilfield water;
viii. comprises any fluid resulting from any part of a process associated with enhanced oil recovery;
ix. comprises produced water;
x. comprises water that is used in and/or results from any part of a gas recovery process;
xi. comprises water that is used in and/or results from any part of the processing of pulp, paper, and/or cardboard;
xii. comprises water that is used in and/or results from any part of reverse osmosis; and/or
xiii. comprises water that is used in and/or results from any part of a geothermal process or application.

7. A method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with one or more glycol ethers, optionally diethylene glycol methyl ether.

8. The method of claim 7, wherein said one or more anti-scalants:
i. exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%;
ii. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or
iii. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%;
wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

9. The method of claim 7 or claim 8, wherein 28 days after addition or introduction, said one or more anti-scalants reach a level of at least 20% biodegradation.

10. The method of any one of claims 7-9, wherein:
i. said maleic anhydride is derivatized with one or more glycol ethers selected from the group consisting of ethylene glycol monomethyl ether (2-methoxyethanol); ethylene glycol monoethyl ether (2-ethoxyethanol); ethylene glycol monopropyl ether (2-propoxyethanol); ethylene glycol monoisopropyl ether (2-isopropoxyethanol); ethylene glycol monobutyl ether (2-butoxyethanol); ethylene glycol monophenyl ether (2-phenoxyethanol); ethylene glycol monobenzyl ether (2-benzyloxyethanol); propylene glycol methyl ether, (1-methoxy-2-propanol); diethylene glycol monomethyl ether (2-(2-methoxyethoxy)ethanol); diethylene glycol monoethyl ether (2-(2-ethoxyethoxy)ethanol); diethylene glycol mono-n-butyl ether (2-(2-butoxyethoxy)ethanol); and dipropyleneglycol methyl ether;
ii. said maleic anhydride is derivatized with diethylene glycol methyl ether (DEGME);
iii. the level of incorporation of the glycol ether in said one or more anti-scalants is about 10% or less, 10% or more, 20% or more, 30% or more, 40% or more, 50% or more, 60% or more, 70% or more, 80% or more, or 90% or more;
iv. the level of incorporation of the glycol ether in said one or more anti-scalants is from about 10% to about 60%, from about 20% to about 60%, from about 30% to about 60%, from about 40% to about 60%, from about 50% to about 60%, from about 30% to about 50%, or from about 40% to about 50%;
v. the molecular weight of said one or more anti-scalants is about 1500 Da or less, 1500 Da or more, 2000 Da or more, 2500 Da or more, 3000 Da or more, 3500 Da or more, 4000 Da or more, 4500 Da or more, 5000 Da or more, or 10000 Da or more;
vi. the molecular weight of the one or more anti-scalants is from about 1500 Da to about 5000 Da;
vii. the maleic anhydride is derivatized with a glycol ether, optionally DEGME; the level of incorporation of the glycol ether is from about 30% to about 60%; and the molecular weight of the biodegradable anti-scalant is from about 1500 Da to about 5000 Da;
viii. the one or more anti-scalants comprise enhanced divalent ion tolerance, optionally wherein said divalent ions comprise calcium and/or magnesium;
ix. the one or more anti-scalants comprise enhanced divalent ion tolerance, wherein said divalent ions comprise calcium and/or magnesium;
x. the ratio of sodium allyl sulfonate:maleic anhydride is from about 0.1:99.9 to 99.9:0.1;
xi. the amount of said one or more anti-scalants added or introduced is 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more;
xii. said scale comprises one or more insoluble salts;
xiii. said scale comprises insoluble salts, including sulfate, carbonate and phosphate salts such as calcium carbonate, calcium sulfate, calcium phosphate, barium sulfate, strontium sulfate, vivianite, iron sulfide, zinc sulfide, lead sulfide, and struvite;
xiv. treatment of said fluid with said one or more anti-scalants results in a 5% reduction or less, a 5% reduction or more, a 10% reduction or more, a 15% reduction or more, a 20% reduction or more, a 25% reduction or more, a 30% reduction or more, a 35% reduction or more, a 40% reduction or more, a 45% reduction or more, a 50% reduction or more, a 55% reduction or more, a 60% reduction or more, a 65% reduction or more, a 70% reduction or more, a 75% reduction or more, an 80% reduction or more, an 85% reduction or more, a 90% reduction or more, a 91% reduction or more, a 92% reduction or more, a 93% reduction or more, a 94% reduction or more, a 95% reduction or more, a 96% reduction or more, a 97% reduction or more, a 98% reduction or more, or a 99% reduction or more of scale formation as compared to a method which did not comprise the use of said one or more biodegradable anti-scalants;
xv. said method comprises adding or introducing an amount of said one or more anti-scalants which is an amount necessary to achieve a desired effect;
xvi. said one or more anti-scalants are provided in liquid form, such as an aqueous solution;
xvii. said one or more anti-scalants are provided in dry form and/or as a powder;
xviii. said one or more anti-scalants are water-soluble;
xix. said addition or introduction of one or more anti-scalants is a continuous application;
xx. said addition or introduction of one or more anti-scalants is a direct injection;
xxi. said addition or introduction of one or more anti-scalants is effected intermittently;
xxii. treatment occurs at atmospheric temperature;
xxiii. treatment occurs at 30° C. or less, 30° C. or more, 35° C. or more, 40° C. or more, 45° C. or more, 50° C. or more, 55° C. or more, 60° C. or more, 65° C. or more, 70° C. or more, 75° C. or more, 80° C. or more, 85° C. or more, 90° C. or more, 95° C. or more, or 100° C. or more, 125° C. or more, or 150° C. or more;
xxiv. the pH at which treatment occurs is the pH of a fluid in need of treatment;
xxv. treatment prevents and/or reduces the plugging of production lines, filters, pumps, and/or screens that are used in conjunction with said fluid in need of treatment;
xxvi. treatment prevents and/or reduces plugging of a fluid conduit disposed in an injection wellbore;
xxvii. treatment prevents and/or reduces plugging of a subterranean formation; and/or
xxviii. treatment prevents and/or reduces plugging of a production well and/or components associated with a production well.

11. The method of any one of claims 7-10, wherein said fluid in need of treatment:
i. comprises a circulating fluid, optionally wherein said circulating fluid comprises any one or more of the following: a circulating fluid utilized in, or a component of, a mining process, or in a system that is utilized in a mining process; a circulating fluid utilized in, or is a component of, a pulp, paper, and/or cardboard-related process, or is in a system that is utilized in a pulp, paper, and/or cardboard-related process; a circulating fluid utilized in, or a component of a reverse osmosis process; a circulating fluid utilized in, or a component of a geothermal application or method; a circulating fluid utilized in, or a component of, an oil and gas exploration or production process, or in a system that is utilized in an oil and gas exploration and production process; a circulating fluid utilized in, or a component of, coal processing, or in a system that is utilized in coal processing (e.g., coal slurry transport);
ii. comprises fluid used in any process or part of a process involved in such process as, but not limited to, a mining process, or a system that is utilized in a mining process; a pulp, paper, and/or cardboard-related process, or a system that is utilized in a pulp, paper, and/or cardboard-related process; a reverse osmosis process, or a system that is utilized in reverse osmosis; a geothermal application or process, or a system that is utilized in a geothermal application or process; an oil and gas exploration or production process, or an oil and gas exploration and production process; or coal processing, or is in a system that is utilized in coal processing (e.g., coal slurry transport);
iii. comprises one or more types of scale, optionally wherein said scale comprises insoluble substances such as insoluble salts, including without limitation sulfate, carbonate and phosphate salts such as calcium carbonate, calcium sulfate, calcium phosphate, barium sulfate, strontium sulfate, vivianite, iron sulfide, zinc sulfide, lead sulfide, and struvite;
iv. comprises boiler water, cooling water, seawater (e.g., in oil platform applications), brackish water, oilfield water (e.g., topside and/or downhole), coal processing water, or industrial treatment plant water;
v. comprises oilfield water in need of treatment;
vi. comprises downhole water that is pumped underground (e.g., for enhanced oil recovery);
vii. comprises topside oilfield water;
viii. comprises any fluid resulting from any part of a process associated with enhanced oil recovery;
ix. comprises produced water;
x. comprises water that is used in and/or results from any part of a gas recovery process;
xi. comprises water that is used in and/or results from any part of the processing of pulp, paper, and/or cardboard;
xii. comprises water that is used in and/or results from any part of reverse osmosis; and/or
xiii. comprises water that is used in and/or results from any part of a geothermal process or application.

12. A composition suitable for use in the treatment of scale, wherein said composition comprises:
i. an effective amount of one or more anti-scalants, wherein said one or more anti-scalants comprise a copolymer of sodium allyl sulfonate and maleic anhydride or its neutralized salt, wherein the maleic anhydride is derivatized with diethylene glycol methyl ether (DEGME), and further wherein the molecular weight of the one or more anti-scalants is from about 1500 Da to about 5000 Da; and optionally
ii. a fluid in need of treatment;
further optionally wherein said one or more anti-scalants are capable of reaching a level of at least 20% biodegradation 28 days after introduction into said fluid in need of treatment, and further optionally wherein said one or more anti-scalants:
(a) exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%;
(b) exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or
(c) exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%;
wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

13. A method for reducing, inhibiting or stabilizing the formation of, or the amount of scale in a fluid, and/or reducing, inhibiting or stabilizing the deposition of scale on a surface in contact with said fluid, wherein said method comprises adding or introducing an amount of one or more anti-scalants to a fluid in need of treatment which is effective to reduce, inhibit or stabilize the formation or amount of scale in said fluid, and/or the deposition of scale on a surface in contact therewith, wherein said one or more anti-scalants comprise a copolymer of sodium allyl sulfonate and maleic anhydride or its neutralized salt, further wherein the maleic anhydride is derivatized with diethylene glycol methyl ether (DEGME), and further wherein the molecular weight of the one or more anti-scalants is from about 1500 Da to about 5000 Da, optionally wherein said one or more anti-scalants are capable of reaching a level of at least 20% biodegradation 28 days after introduction into said fluid in need of treatment, and further optionally wherein said one or more anti-scalants:
i. exhibit enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%;
ii. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or
iii. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%;
wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.

14. An anti-scalant composition comprising a copolymer of sodium allyl sulfonate and maleic anhydride or its neutralized salt, wherein the maleic anhydride is derivatized with diethylene glycol methyl ether (DEGME), and further wherein the molecular weight of the one or more anti-scalants is from about 1500 Da to about 5000 Da; further optionally wherein said anti-scalant composition:
i. exhibits enhanced divalent ion tolerance, optionally calcium and/or magnesium tolerance, further optionally as measured by comparing the 80% transmission value of test solutions comprising the anti-scalant composition and varying concentrations of one or more divalent ions to the 80% transmission value of test solutions which either have no-anti-scalant added or other anti-scalants or biodegradable anti-scalants added, wherein the 80% transmission value is measured at 420 nm wavelength by a spectrophotometer and wherein the value represents the concentration of divalent ions at which the transmission value is 80%;
ii. exhibit a tolerance (as measured by at least 80% transmission) of up to 90,000 mg/L calcium ions, optionally up to 92,000 mg/L calcium ions, optionally wherein the glycol ether comprises DEGME and the level of incorporation is from about 30% to about 60%, optionally from about 30% to about 50%, further optionally from about 30% to about 40%; and/or
iii. exhibit a tolerance (as measured by at least 80% transmission) of up to about 250,000 mg/L (PPM) magnesium ions, optionally wherein the glycol ether comprises DEGME and the level of incorporation is from about 30% to about 60%, optionally from about 30% to about 50%, further optionally from about 30% to about 40%;
wherein optionally the anti-scalant is at a concentration of about 5 ppm or less, 10 ppm or less, 15 ppm or less, 20 ppm or less, 40 ppm or less, 60 ppm or less, 80 ppm or less, 100 ppm or less, 125 ppm or less, 150 ppm or less, 175 ppm or less, 200 ppm or less, 225 ppm or less, 250 ppm or less, 275 ppm or less, 300 ppm or less, 350 ppm or less, 400 ppm or less, 500 ppm or less, 1000 ppm or less, or 1000 ppm or more.
